(19) United States
(12) Patent Application Publication
(10) Pub. No.: US 2026/0003408 A1
(43) Pub. Date: Jan. 1, 2026

(54) PROCESSOR, INFORMATION PROCESSING APPARATUS, AND PROCESSOR CONTROL METHOD

(71) Applicant: Fujitsu Limited, Kawasaki-shi (JP)

(72) Inventor: Takeshi OSONOI, Kawasaki (JP)

(73) Assignee: Fujitsu Limited, Kawasaki-shi (JP)

(21) Appl. No.: 19/247,464

(22) Filed: Jun. 24, 2025

(30) Foreign Application Priority Data
Jul. 1, 2024 (JP) 2024-106369

(51) Int. Cl. G06F 1/26

(52) U.S. Cl. CPC G06F 1/26

(57) ABSTRACT

In a processor, a first allowable power determination circuit determines a smaller value of first request power requested by an entire plurality of calculation devices or first power limit for the entire plurality of calculation devices as a first allowable power allowable to the entire plurality of calculation devices, a second allowable power determination circuit that determines second allowable power for each calculation device based on a smaller value of second request power or second power limit for each calculation device and the first allowable power, and a transmission circuit that transmits the second allowable power to the calculation device to cause the calculation device to receive supply of the second allowable power.

### CROSS-REFERENCE TO RELATED APPLICATION

This application is based upon and claims the benefit of priority of the prior Japanese Patent Application No. 2024-106369, filed on Jul. 1, 2024, the entire contents of which are incorporated herein by reference.

### FIELD

The present invention relates to a processor, an information processing apparatus, and a processor control method.

### BACKGROUND

A plurality of dies may be mounted on the processor. For example, there is a chiplet configuration or the like in which four central processing unit (CPU) core dies and one control die are included in a large scale integration (LSI) package of one processor. The CPU core die includes a plurality of CPU cores and a power control circuit. In addition, the control die includes an allowable power adjustment circuit. The CPU core die is connected to one voltage regulator module (VRM) in pairs, for example, and each of the CPU core dies receives voltage supply from the VRM.

In the processor equipped with the plurality of CPU core dies, the CPU core die transmits, to an allowable power adjustment circuit, request power to be used by each of the CPU core dies for operation. Then, the allowable power adjustment circuit performs power control based on the sequentially changed request power of each CPU core die.

More specifically, during operation, each CPU core mounted on the CPU core die sends a frequency change request to a power control circuit mounted on the CPU core die in accordance with an arithmetic instruction to be executed. The power control circuit transmits power used to operate all the CPU cores in the CPU core die on which the power control circuit is mounted as request power to the allowable power adjustment circuit. The allowable power adjustment circuit determines allowable power for each CPU core die based on a power limit that is an upper limit of predetermined supply power and request power, and transmits information on the determined allowable power to each CPU core die. The power control circuit calculates a CPU core frequency in a range in which the power of the CPU core die in the CPU core die on which the power control circuit is mounted falls within allowable power, issues a frequency change instruction to each CPU core, and changes the voltage of the VRM.

However, in a case where all the dies request large power, or the like, the power may exceed the maximum power supply amount of the voltage regulator that supplies power to the CPU core. Therefore, it is preferable that the allowable power adjustment circuit perform power control of allocating power to each CPU core die so as not to exceed the maximum power supply amount and to correspond to the request power of each CPU core die as much as possible. In the case of performing such power control, a method of determining allowable power by performing strict equal allocation of power so as to correspond to the request power of each CPU core die as much as possible is conceivable.

Note that, as a method of distributing power in a computer, a technique has been proposed in which tokens are associated with a core, tokens are moved from a core with excess tokens to a core that needs additional tokens, and the operating frequency of the core is increased by an increment represented by the token.

The related technology is described, for example, in Japanese National Publication of International Patent Application No. 2023-535564.

However, when the allowable power is determined by performing strict equal allocation, a circuit scale may be increased. For example, when the number of CPU core dies is doubled, the information on the request power is doubled, and a circuit for determining the allowable power for each CPU core die is further added. In addition, when there is a sort circuit of the request power, the sort circuit may increase by the order of the square of the number of CPU core dies. In a divider of a fixed value divisor used to generate the parameter used to determine the allowable power, the number of types of fixed values increases according to the number of the CPU core dies. In addition, when power interchange is performed between different VRMs, the complexity of the circuit increases because the number of CPU core dies to be interchanged increases. As the circuit complexity increases, the number of logic stages increases in addition to an increase in the circuit scale, and the latency may deteriorate.

In addition, the technology for distributing power using tokens does not take into consideration the increase in circuit scale, and when the number of CPU core dies is increased, there is a risk that the circuit scale will increase accordingly.

### SUMMARY

According to an aspect of an embodiment, a processor includes a plurality of calculation devices, a first allowable power determination circuit, a second allowable power determination circuit, and a transmission circuit. The first allowable power determination circuit determines a smaller value of first request power requested by the entire plurality of calculation devices or first power limit for the entire plurality of calculation devices as a first allowable power allowable to the entire plurality of calculation devices. The second allowable power determination circuit that determines second allowable power for each calculation device based on a smaller value of second request power or second power limit for each calculation device and the first allowable power. The transmission circuit that transmits the second allowable power to the calculation device to cause the calculation device to receive supply of the second allowable power.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a hardware configuration diagram of a server according to a first embodiment;

FIG. 2 is a block diagram of an allowable power control circuit;

FIG. 3A is a diagram illustrating an example of a hardware configuration of an allowable power adjustment circuit;

FIG. 3B is a diagram illustrating an example of a hardware configuration of an allowable power adjustment circuit;

FIG. 4 is a diagram illustrating a VRM unit allowable power determination table;

FIG. 5 is a diagram illustrating a die unit allowable power determination table;

FIG. 6 is a flowchart of allowable power adjustment processing by the allowable power adjustment circuit according to the first embodiment;

FIG. 7 is a flowchart of determination processing of package unit allowable power;

FIG. 8 is a flowchart of determination processing of corrected VRM unit request power;

FIG. 9 is a flowchart of determination processing of corrected die unit request power;

FIG. 10 is a flowchart of determination processing of VRM unit allowable power;

FIG. 11 is a flowchart of determination processing of die unit allowable power;

FIG. 12A is a diagram illustrating an example of a circuit in a case where strict equal allocation is performed;

FIG. 12B is a diagram illustrating an example of a circuit in a case where strict equal allocation is performed;

FIG. 13 is a flowchart of the determination processing of the die unit allowable power in a case where strict equal allocation is performed;

FIG. 14 is a hardware configuration diagram according to a second embodiment;

FIG. 15 is a flowchart of allowable power adjustment processing by the allowable power adjustment circuit according to the second embodiment;

FIG. 16 is a flowchart of determination processing of corrected Ln layer request power;

FIG. 17 is a flowchart of determination processing of corrected Li layer request power;

FIG. 18 is a flowchart of determination processing of Li layer allowable power;

FIG. 19 is a flowchart of determination processing of corrected L0 layer request power; and

FIG. 20 is a flowchart of determination processing of L0 layer allowable power.

### DESCRIPTION OF EMBODIMENTS

Preferred embodiments of the present invention will be explained with reference to accompanying drawings. Note that the processor, the information processing apparatus, and the processor control method disclosed in the present application are not limited by the following embodiments.

### [a] First Embodiment

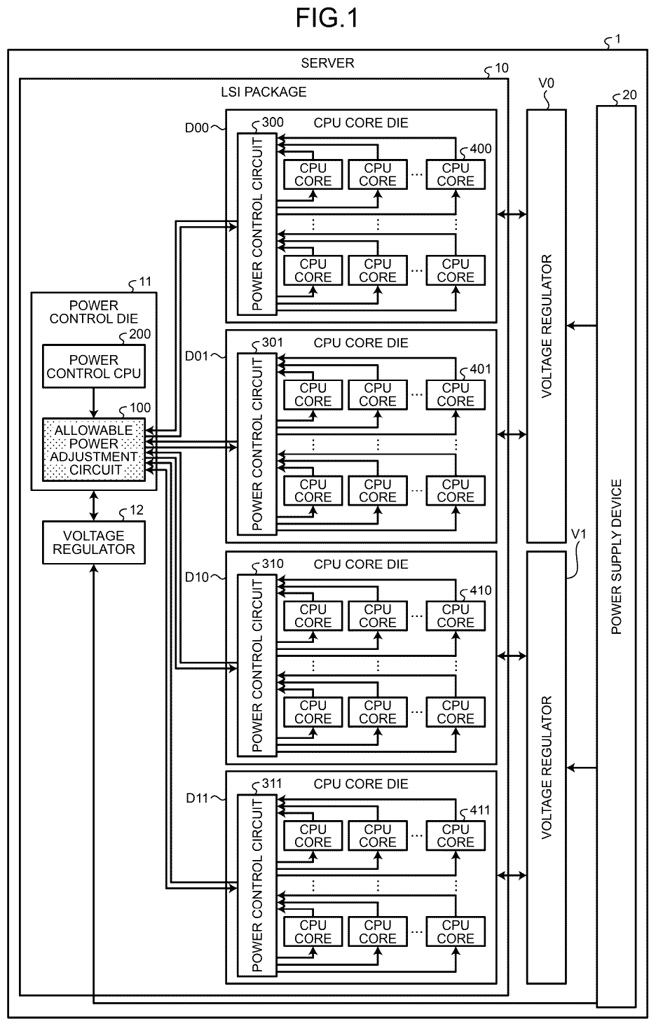

FIG. 1 is a hardware configuration diagram of a server according to a first embodiment. As illustrated in FIG. 1, a server 1 which is an information processing apparatus includes an LSI package 10, voltage regulators (VRM) V0 and V1, and a power supply device 20.

The LSI package 10 is a processor and may be referred to as a chiplet. The LSI package 10 according to the present embodiment includes a power control die 11, a voltage regulator 12, and CPU core dies D00, D01, D10, and D11. However, the four CPU core dies D00, D01, D10, and D11 are examples, and the number thereof is not particularly limited. The CPU core dies D00, D01, D10, and D11 correspond to an example of a “plurality of calculation mechanisms”.

The voltage regulators V0 and V1 receive power supply from the power supply device 20. Then, the voltage regulator V0 keeps the voltage constant and supplies power to the CPU core dies D00 and D01. In addition, the voltage regulator V1 supplies power to the CPU core dies D10 and D11 while keeping the voltage constant. Here, in the present embodiment, the CPU core dies D00 and D01 are connected to the voltage regulator V0, and the two CPU core dies D10 and D11 are connected to the voltage regulator V1, but this number is not particularly limited. In addition, a case where two voltage regulators V0 and V1 are mounted on the LSI package 10 will be described, but the number of voltage regulators V0 and V1 is not particularly limited.

The CPU core die D00 includes a power control circuit 300 and a plurality of CPU cores 400. The CPU core die D01 includes a power control circuit 301 and a plurality of CPU cores 401. The CPU core die D10 includes a power control circuit 310 and a plurality of CPU cores 410. The CPU core die D11 includes a power control circuit 311 and a plurality of CPU cores 411.

The CPU core dies D00 and D01 are included in a set of die groups that receive power supply from the same voltage regulator V0. In addition, the CPU core dies D10 and D11 are included in one die group that receives power supply from the same voltage regulator V1. Here, since the CPU core dies D00, D01, D10, and D11 have similar functions, the CPU core die D00 will be described as an example.

The CPU core 400 notifies the power control circuit 300 of the die unit request power to be used for the operation. Thereafter, the CPU core 400 receives the power supply from the voltage regulator V0, and performs operation by being driven by the supplied power.

The power control circuit 300 receives notification of the die unit request power from each of the CPU cores 400. Then, the power control circuit 300 calculates the die unit request power of the CPU core die D00 by summing the die unit request power. Hereinafter, the die unit request power of the CPU core die D00 is referred to as D00 request power. The power control circuit 300 notifies an allowable power adjustment circuit 100 of the D00 request power.

Thereafter, the power control circuit 300 receives the die unit allowable power of the CPU core die D00 from the allowable power adjustment circuit 100. Hereinafter, the die unit allowable power of the CPU core die D00 is referred to as D00 allowable power. Then, the power control circuit 300 instructs the voltage regulator V0 to change the voltage such that the power consumption of the CPU core die D00 is equal to or less than the power indicated by the D00 allowable power, and instructs each CPU core 400 to change the frequency.

The voltage regulator 12 receives power supply from the power supply device 20. Then, the voltage regulator 12 supplies power to the power control die 11 while keeping the voltage constant.

The power control die 11 includes an allowable power adjustment circuit 100 and a power control CPU 200. The power control CPU 200 operates an operating system (OS) and firmware. The OS and firmware operated by the power control CPU 200 transmit predetermined package unit power limit, VRM unit power limit, and die unit power limit to the allowable power adjustment circuit 100.

The package unit power limit is a power limit corresponding to an upper limit value of power that can be provided to the entire LSI package 10. The VRM unit power limit is a power limit for the two CPU core dies D00 and D01 sharing the voltage regulator V0, and a power limit for the two CPU core dies D10 and D11 sharing the voltage regulator V1. The die unit power limit is a power limit for each of the CPU core dies D00, D01, D10, and D11.

Here, the magnitude relationship among the values per die of the package unit power limit, the VRM unit power limit, and the die unit power limit is: package unit power limit/4≤VRM unit power limit/2≤die unit power limit. For example, in a case of VRM unit power limit/2>die unit power limit, even if the supply power to the CPU core die D00 is set as the die unit power limit, the supply power to the two CPU core dies D00 and D01 of the VRM unit power limit does not reach the die unit power limit. Therefore, when the magnitude relationship is opposite, the operation of the allowable power adjustment circuit 100 is the same as the case of VRM unit power limit/2=die unit power limit. That is, the allocation of the allowable power can be determined based on the above-described magnitude relationship.

The allowable power adjustment circuit 100 receives the package unit power limit, the VRM unit power limit, and the die unit power limit from the power control CPU 200. In addition, the allowable power adjustment circuit 100 receives the die unit request power from each of the power control circuits 300, 301, 310, and 311. Then, the allowable power adjustment circuit 100 determines the die unit supply power to each of the CPU core dies D00, D01, D10, and D11 using the package unit power limit, the VRM unit power limit, the die unit power limit, and the die unit request power. Thereafter, the allowable power adjustment circuit 100 transmits the determined die unit supply power to each of the power control circuits 300, 301, 310, and 311.

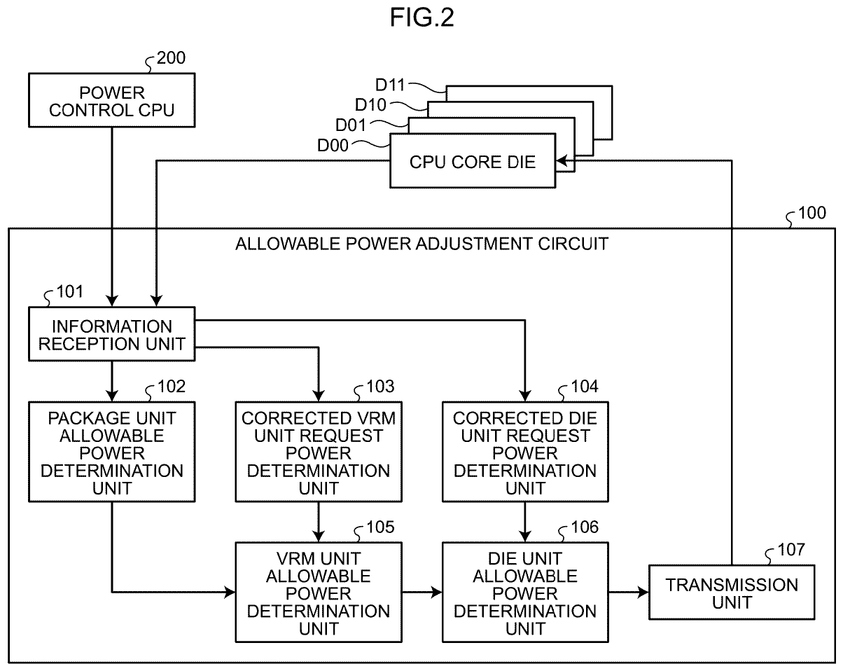

FIG. 2 is a block diagram of an allowable power control circuit. Next, determination of the die unit supply power by the allowable power adjustment circuit 100 will be described in detail with reference to FIG. 2. As illustrated in FIG. 2, the allowable power adjustment circuit 100 includes an information reception unit 101, a package unit allowable power determination unit 102, a corrected VRM unit request power determination unit 103, and a corrected die unit request power determination unit 104. Furthermore, the allowable power adjustment circuit 100 includes a VRM unit allowable power determination unit 105, a die unit allowable power determination unit 106, and a transmission unit 107.

The information reception unit 101 is an interface for receiving information. The information reception unit 101 receives the package unit power limit, the VRM unit power limit, and the die unit power limit transmitted from the power control CPU 200. In addition, the information reception unit 101 receives the die unit request power of the CPU core dies D00, D01, D10, and D11 from the power control circuits 300, 301, 310, and 311, respectively.

Then, the information reception unit 101 outputs the package unit power limit and the die unit request power of the CPU core dies D00, D01, D10, and D11 to the package unit allowable power determination unit 102. In addition, the information reception unit 101 outputs the VRM unit power limit and the die unit request power of the CPU core dies D00, D01, D10, and D11 to the corrected VRM unit request power determination unit 103. In addition, the information reception unit 101 outputs the die unit power limit and the die unit request power of the CPU core dies D00, D01, D10, and D11 to the corrected die unit request power determination unit 104.

The package unit allowable power determination unit 102 receives the input of the package unit power limit and the die unit request power of the CPU core dies D00, D01, D10, and D11 from the information reception unit 101. Then, the package unit allowable power determination unit 102 calculates the package unit request power which is the request power of the entire LSI package 10 by summing the die unit request power of the CPU core dies D00, D01, D10, and D11.

Next, the package unit allowable power determination unit 102 determines whether or not the package unit request power is larger than the package unit power limit. When the package unit request power is larger than the package unit power limit, the package unit allowable power determination unit 102 sets the package unit power limit as corrected package unit request power. When the package unit request power is equal to or less than the package unit power limit, the package unit allowable power determination unit 102 sets the package unit request power as the corrected package unit request power. Then, the package unit allowable power determination unit 102 sets the corrected package unit request power as the package unit allowable power corresponding to the allowable power of the entire LSI package 10. Thereafter, the package unit allowable power determination unit 102 outputs the package unit allowable power to the VRM unit allowable power determination unit 105.

The package unit allowable power determination unit 102 corresponds to an example of a “first allowable power determination unit”. The package unit request power corresponds to an example of “first request power requested by the entire plurality of calculation mechanisms”. In addition, the package unit power limit corresponds to an example of a “first power limit for the entire plurality of calculation mechanisms”. The package allowable power corresponds to an example of “first allowable power allowable to the entire plurality of calculation mechanisms”. That is, the package unit allowable power determination unit 102 determines the smaller value of the first request power or the first power limit as the first allowable power. Further, the die unit request power of the CPU core dies D00, D01, D10, and D11 corresponds to an example of “second request power”. Then, the package unit allowable power determination unit 102 calculates the package request power which is the first request power by summing the die unit request power of the CPU core dies D00, D01, D10, and D11 which is the second request power.

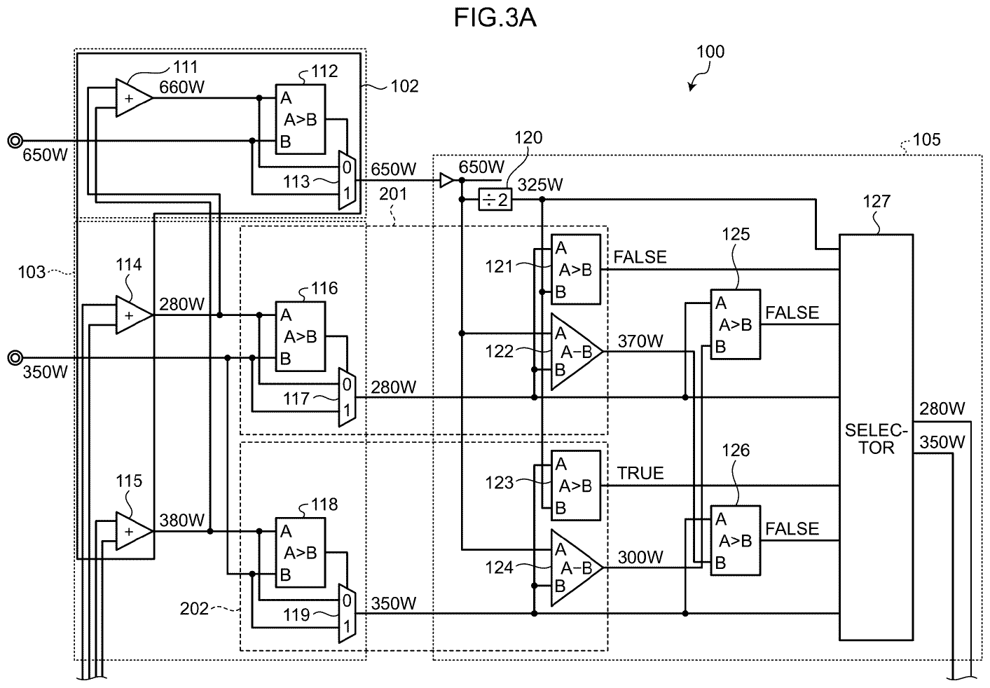

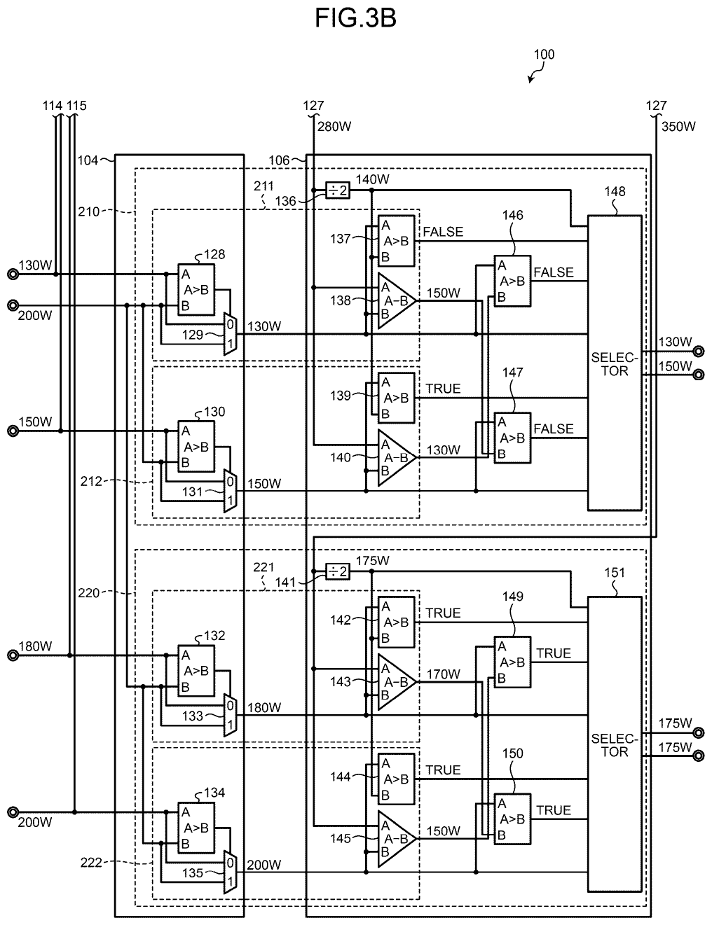

FIG. 3 is a diagram illustrating an example of a hardware configuration of an allowable power adjustment circuit. The power described in the vicinity of each element in FIG. 3 corresponds to an example of a power value output from each element under the following conditions. This is an example of a power value when the package power limit is 650 W, the VLM unit power limit is 350 W, and the die unit power limit is 200 W. In addition, this is an example of a power value in a case where the D00 request power is 130 W, the D01 request power is 150 W, the D10 request power is 180 W, and the D11 request power is 200 W. Hereinafter, this condition is referred to as an explanatory condition.

The allowable power adjustment circuit 100 can be realized by the hardware configuration illustrated in FIG. 3. Here, a circuit 201 and the circuit 202 have similar circuit configurations. In addition, a circuit 210 and the circuit 220 have similar circuit configurations. Further, circuits 211, 212, 221, and 222 have a similar circuit configuration.

The function of the package unit allowable power determination unit 102 is realized by, for example, an adder 111, a comparator 112, a multiplexer 113, an adder 114, and an adder 115. Here, the request powers of the CPU core dies D00, D01, D10, and D11 are referred to as D00 request power, D01 request power, D10 request power, and D11 request power, respectively.

Upon receiving the input of the D00 request power and the D01 request power, the adder 114 adds the D00 request power and the D01 request power, and calculates and outputs the VRM unit request power which is the entire power request of the die group requesting the power supply to the voltage regulator V0. Hereinafter, the VRM unit request power which is the entire power request of the die group requesting the power supply to the voltage regulator V0 is referred to as V0 request power. For example, in the case of the explanatory condition, the adder 114 outputs 130 W+150 W=280 W.

In addition, upon receiving the input of the D10 request power and the D11 request power, the adder 115 adds the D10 request power and the D11 request power, and calculates and outputs the VRM unit request power which is the entire power request of the die group requesting the power supply to the voltage regulator V1. Hereinafter, the VRM unit request power which is the entire power request of the die group requesting the power supply to the voltage regulator V1 is referred to as V1 request power. In addition, the V0 request power and the V1 request power are collectively referred to as VRM unit request power. For example, in the case of the explanatory condition, the adder 115 outputs 180 W+200 W=380 W.

The adder 111 receives an input of the V0 request power from the adder 114. In addition, the adder 111 receives an input of the V1 request power from the adder 115. Then, the adder 111 adds the V0 request power and the V1 request power to calculate and output the package unit request power. For example, in the case of the explanatory condition, the adder 111 outputs 280 W+380 W=660 W.

The comparator 112 receives the input of the package unit request power output from the adder 111. In addition, the comparator 112 receives an input of a package unit power limit. Then, the comparator 112 compares the package unit request power with the package unit power limit. The comparator 112 outputs 1 when the package unit request power is larger than the package unit power limit. In addition, the comparator 112 outputs 0 when the package unit request power is equal to or higher than the package unit power limit. For example, in the case of the explanatory condition, since the package unit request power is 660 W and the package unit power limit is 650 W, the comparator 112 outputs 1.

The multiplexer 113 receives the input of the package unit request power output from the adder 111. Further, the multiplexer 113 receives an input of the package unit power limit. Then, the multiplexer 113 receives the input of the output value from the comparator 112, and outputs the package unit request power when the output value from the comparator 112 is 0. Conversely, when the output value from the comparator 112 is 1, the multiplexer 113 outputs the package unit power limit. The information output from the multiplexer 113 is the corrected package unit request power, and corresponds to the package unit allowable power. For example, in the case of the explanatory condition, since the output value from the comparator 112 is 1, the multiplexer 113 outputs 650 W.

Returning to FIG. 2, the description will be continued. The corrected VRM unit request power determination unit 103 receives an input of the VRM unit power limit and the die unit request power of the CPU core dies D00, D01, D10, and D11 from the information reception unit 101. Next, the corrected VRM unit request power determination unit 103 calculates the V0 request power by summing the D00 request power and the D01 request power. The corrected VRM unit request power determination unit 103 calculates the V1 request power by summing the D10 request power and the D11 request power.

Next, the corrected VRM unit request power determination unit 103 sequentially selects the voltage regulator V0 or V1. For example, when the voltage regulator V0 is selected, the corrected VRM unit request power determination unit 103 determines whether the V0 request power is larger than the VRM unit power limit. When the V0 request power is larger than the VRM unit power limit, the corrected VRM unit request power determination unit 103 sets the VRM unit power limit to the corrected V0 request power obtained by correcting the V0 request power. When the V0 request power is equal to or less than the VRM unit power limit, the corrected VRM unit request power determination unit 103 sets the V0 request power as the corrected V0 request power.

The corrected VRM unit request power determination unit 103 similarly calculates the corrected V1 request power for the V1 request power. Thereafter, the corrected VRM unit request power determination unit 103 outputs the corrected V0 request power and the corrected V1 request power to the VRM unit allowable power determination unit 105.

The die groups of the CPU core dies D00 and D01 and the die groups of the CPU core dies D10 and D11 correspond to examples of “the plurality of calculation mechanisms divided into a plurality of groups”. The VRM unit request power corresponds to an example of “third request power”. The VRM unit power limit corresponds to an example of a “third power limit”. The corrected VRM unit request power corresponds to an example of “corrected third request power”. The corrected VRM unit request power determination unit 103 corresponds to an example of a “corrected third request power determination unit”. For each of the voltage regulators V0 and V1, the corrected VRM unit request power determination unit 103 calculates the third request power by summing the second request power for each calculation mechanism that supplies power, and sets the smaller value of the third request power or the third power limit as the corrected third request power.

An example of a hardware configuration that implements the function of the corrected VRM unit request power determination unit 103 will be described with reference to FIG. 3. The function of the corrected VRM unit request power determination unit 103 is realized by, for example, the adder 114, the adder 115, a comparator 116, a multiplexer 117, a comparator 118, and a multiplexer 119.

Upon receiving the input of the D00 request power and the D01 request power, the adder 114 adds the D00 request power and the D01 request power to calculate the V0 request power. In addition, the adder 115 receives the D10 request power and the D11 request power, and adds the D10 request power and the D11 request power to calculate the V1 request power.

The comparator 116 receives an input of the V0 request power from the adder 114. In addition, the comparator 116 receives an input of the VRM unit power limit. Then, the comparator 116 compares the V0 request power with the VRM unit power limit. When the V0 request power is larger than the VRM unit power limit, the comparator 116 outputs 1. In addition, the comparator 116 outputs 0 when the V0 request power is equal to or less than the VRM unit power limit. For example, in the case of the explanatory condition, since the V0 request power is 280 W and the VRM unit power limit is 350 W, the comparator 116 outputs 0.

The multiplexer 117 receives an input of the V0 request power from the adder 114. Further, the multiplexer 117 receives an input of the VRM unit power limit. Further, the multiplexer 117 receives an input of an output value from the comparator 116. When the output value from the comparator 116 is 0, the multiplexer 117 outputs the V0 request power. When the output value from the comparator 116 is 1, the multiplexer 117 outputs the VRM power limit. The information output from the multiplexer 117 corresponds to the corrected V0 request power. For example, in the case of the explanatory condition, since the output value from the comparator 116 is 0, the multiplexer 117 outputs 280 W.

The comparator 118 and the multiplexer 119 also output either the V1 request power or the VRM power limit similarly to the comparator 116 and the multiplexer 117 based on the V1 request power and the VRM power limit. The information output from the multiplexer 119 corresponds to the corrected V1 request power. For example, in the case of the explanatory condition, since the V1 request power is 380 and the VRM unit power limit is 350 W, the comparator 116 outputs 1, and the multiplexer 119 outputs 350 W.

Returning to FIG. 2, the description will be continued. The corrected die unit request power determination unit 104 receives an input of the die unit power limit and the die unit request power of the CPU core dies D00, D01, D10, and D11 from the information reception unit 101. Next, the corrected die unit request power determination unit 104 sequentially selects the CPU core die D00, D01, D10, or D11.

For example, when the CPU core die D00 is selected, the corrected die unit request power determination unit 104 determines whether the D00 request power is larger than the die unit power limit. When the D00 request power is larger than the die unit power limit, the corrected die unit request power determination unit 104 sets the die unit power limit to the corrected D00 request power obtained by correcting the D00 request power. When the D00 request power is equal to or less than the die unit power limit, the corrected die unit request power determination unit 104 sets the D00 request power as the corrected D00 request power.

The corrected die unit request power determination unit 104 similarly calculates the corrected D01 request power, the corrected D10 request power, and the corrected D11 request power for the D01, D10, and D11 request powers. Thereafter, the corrected die unit request power determination unit 104 outputs the corrected D00 request power, the corrected D01 request power, the corrected D10 request power, and the corrected D11 request power to the die unit allowable power determination unit 106.

The die unit power limit for the CPU core dies D00, D01, D10, and D11 corresponds to an example of the “second power limit”. In addition, the corrected D00 request power, the corrected D01 request power, the corrected D10 request power, and the corrected D11 request power correspond to an example of “corrected second request power” for each calculation mechanism. In addition, the corrected die unit request power determination unit 104 corresponds to an example of a “corrected second request power determination unit”. The corrected die unit request power determination unit 104 sets the smaller value of the second request power or the second power limit as the corrected second request power for each calculation mechanism.

An example of a hardware configuration that implements the function of the corrected die unit request power determination unit 104 will be described with reference to FIG. 3. The function of the corrected die unit request power determination unit 104 is realized by a comparator 128, a multiplexer 129, a comparator 130, a multiplexer 131, a comparator 132, and a multiplexer 133.

The comparator 128 receives an input of the D00 request power. In addition, the comparator 128 receives an input of a die unit power limit. Then, the comparator 128 compares the D00 request power with the die unit power limit. When the D00 request power is larger than the die unit power limit, the comparator 128 outputs 1. In addition, the comparator 128 outputs 0 when the D00 request power is equal to or less than the die unit power limit. For example, in the case of the explanatory condition, since the D00 request power is 130 W and the die unit power limit is 200 W, the comparator 128 outputs 0.

The multiplexer 129 receives an input of the D00 request power. Furthermore, the multiplexer 129 receives an input of a die unit power limit. Further, the multiplexer 129 receives an input of an output value from the comparator 128. When the output value from the comparator 128 is 0, the multiplexer 129 outputs the D00 request power. When the output value from the comparator 128 is 1, the multiplexer 129 outputs the core power limit. The information output from the multiplexer 129 corresponds to the corrected D00 request power. For example, in the case of the explanatory condition, since 0 is output from the comparator 128, the multiplexer 129 outputs 130 W.

The comparator 130 and the multiplexer 131 output the D01 request power or the core power limit similarly to the comparator 128 and the multiplexer 129 based on the D01 request power and the die unit power limit. The information output from the multiplexer 131 corresponds to the corrected D01 request power. For example, in the case of the explanatory condition, 0 is output from the comparator 130, and the multiplexer 131 outputs 150 W.

The comparator 132 and the multiplexer 133 output the D10 request power or the core power limit similarly to the comparator 128 and the multiplexer 129 based on the D10 request power and the die unit power limit. The information output from the multiplexer 133 corresponds to the corrected D10 request power. For example, in the case of the explanatory condition, 0 is output from the comparator 132, and the multiplexer 133 outputs 150 W.

A comparator 134 and a multiplexer 135 output the D11 request power or the core power limit similarly to the comparator 128 and the multiplexer 129 based on the D11 request power and the die unit power limit. The information output from the multiplexer 135 corresponds to the corrected D11 request power. For example, in the case of the explanatory condition, 1 is output from the comparator 134, and the multiplexer 135 outputs 200 W.

Returning to FIG. 2, the description will be continued. The VRM unit allowable power determination unit 105 receives an input of the package unit allowable power from the package unit allowable power determination unit 102. In addition, the VRM unit allowable power determination unit 105 receives the input of the corrected V0 request power and the corrected V1 request power, which are the corrected VRM unit request power, from the corrected VRM unit request power determination unit 103. Next, the VRM unit allowable power determination unit 105 sequentially selects the voltage regulator V0 and the voltage regulator V1.

For example, when the voltage regulator V0 is selected, the VRM unit allowable power determination unit 105 compares the corrected V0 request power with half of the package unit allowable power. When the corrected V0 request power is half or less of the package unit allowable power, the VRM unit allowable power determination unit 105 sets the V0 allowable power, which is the entire allowable power of one set of die groups supplied with power from the voltage regulator V0, as the corrected V0 request power.

On the other hand, when the corrected V0 request power is larger than half of the package unit allowable power, the VRM unit allowable power determination unit 105 compares the corrected V1 request power with half of the package unit allowable power. When the corrected V1 request power is larger than half of the package unit allowable power, the VRM unit allowable power determination unit 105 sets the V0 allowable power to half of the package unit allowable power.

On the other hand, when the corrected V1 request power is half or less of the package unit allowable power, the VRM unit allowable power determination unit 105 compares a value obtained by subtracting the corrected V1 request power from the package unit allowable power with the corrected V0 request power. When the corrected V0 request power is larger than a value obtained by subtracting the corrected V1 request power from the package unit allowable power, the VRM unit allowable power determination unit 105 sets a value obtained by subtracting the corrected V1 request power from the package unit allowable power as the V0 allowable power.

On the other hand, when the corrected V0 request power is equal to or less than a value obtained by subtracting the corrected V1 request power from the package unit allowable power, the VRM unit allowable power determination unit 105 sets the corrected V0 request power as the V0 allowable power.

A VRM unit allowable power determination unit 105 similarly calculates the V1 allowable power using the package unit allowable power and the corrected V1 request power. Thereafter, the VRM unit allowable power determination unit 105 outputs the V0 allowable power and the V1 allowable power to the die unit allowable power determination unit 106.

The VRM unit allowable power corresponds to an example of “third allowable power”. Moreover, the VRM unit allowable power determination unit 105 corresponds to an example of a “third allowable power determination unit”. The VRM unit allowable power determination unit 105 determines the third allowable power for each group based on the smaller value of the third request power or the third power limit and the first allowable power for each of voltage regulators V0 and V1. In this embodiment, the number of voltage regulators V0 and V1 mounted on the server 1, which is two, is an example of a “first predetermined number”. That is, the VRM unit allowable power determination unit 105 determines the third allowable power for each of voltage regulators V0 and V1 based on the corrected third request power and a value obtained by dividing the first allowable power by the first predetermined number.

An example of a hardware configuration for implementing the function of the VRM unit allowable power determination unit 105 will be described with reference to FIG. 3. The function of the VRM unit allowable power determination unit 105 is realized by a divider 120, a comparator 121, a subtractor 122, a comparator 123, a subtractor 124, a comparator 125, a comparator 126, and a selector 127.

The divider 120 receives the input of the package unit allowable power output from the multiplexer 113. Next, the divider 120 performs division by 2 by shifting the data of the package unit allowable power to the right by 1 bit. Then, the divider 120 outputs the package unit allowable power×½. For example, in the case of the explanatory condition, since the package unit allowable power is 650 W, the divider 120 outputs 325 W.

The comparator 121 receives the input of the corrected V0 request power output from the multiplexer 117. In addition, the comparator 121 receives an input of half of the package unit allowable power output from the divider 120. Next, the comparator 121 compares the corrected V0 request power with half of the package unit allowable power. When the corrected V0 request power is larger than half of the package unit allowable power, the comparator 121 outputs 1 indicating True. In addition, the comparator 121 outputs 0 indicating False when the corrected V0 request power is half or less of the package unit allowable power. For example, in the case of the explanatory condition, since the corrected V0 request power is 280 W and half of the package unit allowable power is 325 W, the comparator 121 outputs 0.

The subtractor 122 receives the input of the package unit allowable power output from the multiplexer 113. In addition, the subtractor 122 receives the input of the corrected V0 request power output from the multiplexer 117. Next, the subtractor 122 outputs a value obtained by subtracting the corrected V0 request power from the package unit allowable power. For example, in the case of the explanatory condition, since the package unit allowable power is 650 W and the corrected V0 request power is 280 W, the subtractor 122 outputs 370 W.

The comparator 123 receives the input of the corrected V1 request power output from the multiplexer 119. In addition, the comparator 123 receives an input of half of the package unit allowable power output from the divider 120. Next, the comparator 123 compares the corrected V1 request power with half of the package unit allowable power. When the corrected V1 request power is larger than half of the package unit allowable power, the comparator 123 outputs 1 indicating True. In addition, the comparator 123 outputs 0 indicating False when the corrected V1 request power is half or less of the package unit allowable power. For example, in the case of the explanatory condition, since the corrected V1 request power is 350 W and half of the package unit allowable power is 325 W, the comparator 121 outputs 1.

The subtractor 124 receives the input of the package unit request power output from the multiplexer 113. In addition, the subtractor 124 receives the input of the corrected V1 request power output from the multiplexer 119. Next, the subtractor 122 outputs a value obtained by subtracting the corrected V1 request power from the package unit request power. For example, in the case of the explanatory condition, since the package unit allowable power is 650 W and the corrected V1 request power is 350 W, the comparator 121 outputs 300 W.

The comparator 125 receives the input of the corrected V0 request power output from the multiplexer 117. In addition, the comparator 125 receives an input of a value obtained by subtracting the corrected V1 request power from the package unit allowable power output from the subtractor 124. Then, the comparator 125 compares the corrected V0 request power with a value obtained by subtracting the corrected V1 request power from the package unit allowable power. When the corrected V0 request power is larger than the value obtained by subtracting the corrected V1 request power from the package unit allowable power, the comparator 125 outputs 1 indicating True. When the corrected V0 request power is equal to or less than the value obtained by subtracting the corrected V1 request power from the package unit allowable power, the comparator 125 outputs 0 indicating False. For example, in the case of the explanatory condition, since the corrected V0 request power is 280 W and the value obtained by subtracting the corrected V1 request power from the package unit allowable power is 300 W, the comparator 125 outputs 0.

The comparator 126 receives the input of the corrected V1 request power output from the multiplexer 119. In addition, the comparator 126 receives an input of a value obtained by subtracting the corrected V0 request power from the package unit allowable power output from the subtractor 122. Then, the comparator 126 compares the corrected V1 request power with a value obtained by subtracting the corrected V0 request power from the package unit allowable power. When the corrected V1 request power is larger than the value obtained by subtracting the corrected V0 request power from the package unit allowable power, the comparator 125 outputs 1 indicating True. When the corrected V1 request power is equal to or less than the value obtained by subtracting the corrected V0 request power from the package unit allowable power, the comparator 125 outputs 0 indicating False. For example, in the case of the explanatory condition, since the corrected V1 request power is 350 W and the value obtained by subtracting the corrected V0 request power from the package unit allowable power is 370 W, the comparator 126 outputs 0.

The selector 127 receives inputs of the package unit allowable power×½ output from the divider 120, the corrected V0 request power output from the multiplexer 117, and the corrected V1 request power output from the multiplexer 119. In addition, the selector 127 receives inputs of an output value of the comparator 121, an output value of the comparator 123, an output value of the comparator 125, and an output value of the comparator 126.

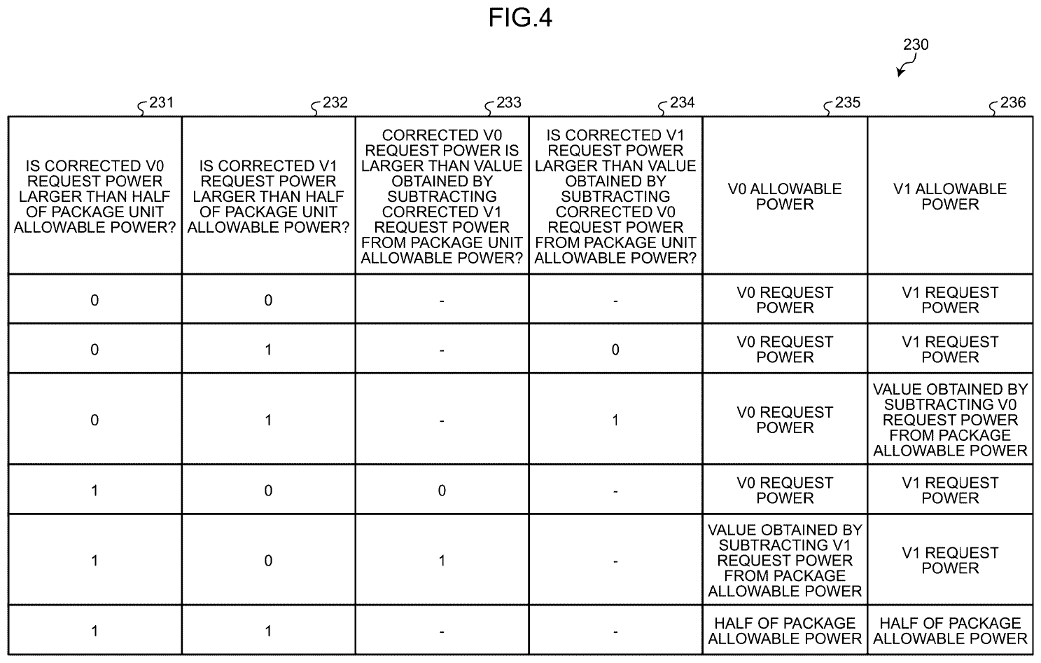

FIG. 4 is a diagram illustrating a VRM unit allowable power determination table. In a VRM unit allowable power determination table 230, a column 231 indicates an output value of the comparator 121. In addition, a column 232 indicates an output value of the comparator 123. In addition, a column 233 indicates an output value of the comparator 125. In addition, a column 234 indicates an output value of the comparator 126. A column 235 corresponds to the V0 allowable power output from the selector 127. A column 236 corresponds to the V1 allowable power output from the selector 127. Further, in the VRM unit allowable power determination table 230, the item in which “-(hyphen)” is registered is an item that does not affect the selection of the selector 127 regardless of the value.

The selector 127 includes the VRM unit allowable power determination table 230 illustrated in FIG. 4. The selector 127 determines data to be selected according to the VRM unit allowable power determination table 230 based on the output value of the comparator 121, the output value of the comparator 123, the output value of the comparator 125, and the output value of the comparator 126. Then, the selector 127 outputs the data selected as the V0 allowable power and the V1 allowable power. For example, in the case of the explanatory condition, since the output values of the comparators 121, 123, 125, and 126 are 0, 1, 0, and 0, respectively, the selector 127 outputs 280 W as the V0 allowable power and outputs 350 W as the V1 allowable power.

Returning to FIG. 2, the description will be continued. The die unit allowable power determination unit 106 receives inputs of the corrected D00 request power, the corrected D01 request power, the corrected D10 request power, and the corrected D11 request power from the corrected die unit request power determination unit 104. In addition, the die unit allowable power determination unit 106 receives inputs of the V0 allowable power and the V1 allowable power from the VRM unit allowable power determination unit 105. Next, the die unit allowable power determination unit 106 sequentially selects the voltage regulator V0 and the voltage regulator V1.

When the voltage regulator V0 is selected, next, the die unit allowable power determination unit 106 sequentially selects the CPU core die D00 or D01. For example, when the CPU core die D00 is selected, the die unit allowable power determination unit 106 compares the corrected D00 request power and half of the V0 allowable power. When the corrected D00 request power is half or less of the V0 allowable power, the die unit allowable power determination unit 106 sets the corrected D00 request power as D00 allowable power which is power allowed for the CPU core die D00.

On the other hand, when the corrected D00 request power is larger than half of the V0 allowable power, the die unit allowable power determination unit 106 compares the corrected D01 request power with half of the V0 allowable power. When the corrected D01 request power is larger than half of the V0 allowable power, the die unit allowable power determination unit 106 sets half of the V0 allowable power as the D00 allowable power.

On the other hand, when the corrected D01 request power is half or less of the V0 allowable power, the die unit allowable power determination unit 106 compares a value obtained by subtracting the corrected D01 request power from the V0 allowable power with the corrected D00 request power. When the corrected D00 request power is larger than a value obtained by subtracting the corrected D01 request power from the V0 allowable power, the die unit allowable power determination unit 106 sets a value obtained by subtracting the corrected D01 request power from the V0 allowable power as the D00 allowable power.

On the other hand, when the corrected D00 request power is equal to or less than a value obtained by subtracting the corrected D01 request power from the V0 allowable power, the die unit allowable power determination unit 106 sets the corrected D00 request power as the D00 allowable power.

The die unit allowable power determination unit 106 similarly determines the D01 allowable power. In addition, the die unit allowable power determination unit 106 similarly determines the D10 allowable power and the D11 allowable power by using the V1 allowable power, the corrected D10 request power, and the corrected D11 request power. Thereafter, the die unit allowable power determination unit 106 outputs the D00 allowable power, the D01 allowable power, the D10 allowable power, and the D11 allowable power to the transmission unit 107.

The die unit allowable power determination unit 106 corresponds to an example of a “second allowable power determination unit”. For each of the CPU core dies D00, D01, D10, and D11 which are calculation mechanisms, the die unit allowable power determination unit 106 determines the second allowable power for each calculation mechanism based on the smaller value of the 2 request power or the second power limit and the first allowable power. In addition, the die unit allowable power determination unit 106 determines the second allowable power for each calculation mechanism based on the smaller value of the second request power or the second power limit for each calculation mechanism and the third allowable power. In addition, in the present embodiment, 2, which is the number of the CPU core dies D00 and D01 to which the voltage regulator V0 supplies power and the number of the CPU core dies D10 and D11 to which the voltage regulator V0 supplies power, corresponds to an example of the “second predetermined number”. The die unit allowable power determination unit 106 determines the second allowable power for each calculation mechanism based on the corrected second request power and a value obtained by dividing the third allowable power of the voltage regulator V0 or V1 of the power supply source by the second predetermined number.

An example of a hardware configuration for implementing the function of the die unit allowable power determination unit 106 will be described with reference to FIG. 3. The function of the die unit allowable power determination unit 106 is realized by a divider 136, a comparator 137, a subtractor 138, a comparator 139, a subtractor 140, a divider 141, a comparator 142, a subtractor 143, a comparator 144, and a subtractor 145. In addition, the function of the die unit allowable power determination unit 106 is realized by a comparator 146, a comparator 147, a selector 148, a comparator 149, a comparator 150, and a selector 151.

The divider 136 receives the input of the V0 allowable power output from the selector 127. Next, the divider 136 performs division by 2 by shifting the data of the V0 allowable power to the right by 1 bit. Then, the divider 136 outputs a half value of the V0 allowable power. For example, in the case of the explanatory condition, since the V0 allowable power is 280 W, the divider 136 outputs 140 W.

The comparator 137 receives the input of the corrected D00 request power output from the multiplexer 129. In addition, the comparator 137 receives an input of a half value of the V0 allowable power output from the divider 136. Next, the comparator 137 compares the corrected D00 request power with half of the V0 allowable power. When the corrected D00 request power is larger than half of the V0 allowable power, the comparator 137 outputs 1 indicating True. In addition, the comparator 137 outputs 0 indicating False when the corrected D00 request power is half or less of the V0 allowable power. For example, in the case of the explanatory condition, since the corrected D00 request power is 130 W and V0 allowable power×½ is 140 W, the comparator 121 outputs 0.

The subtractor 138 receives the input of the V0 allowable power output from the selector 127. In addition, the subtractor 138 receives the input of the corrected D00 request power output from the multiplexer 129. Next, the subtractor 138 outputs a value obtained by subtracting the corrected D00 request power from the V0 allowable power. For example, in the case of the explanatory condition, since the V0 allowable power is 280 W and the corrected D00 request power is 130 W, the subtractor 138 outputs 150 W.

The comparator 139 receives the input of the corrected D01 request power output from the multiplexer 131. In addition, the comparator 139 receives the input of V0 allowable power×½ output from the divider 136. Next, the comparator 137 compares the corrected D01 request power with V0 allowable power×½. When the corrected D01 request power is larger than V0 allowable power×½, the comparator 137 outputs 1 indicating True. When the corrected D01 request power is equal to or less than V0 allowable power×½, the comparator 137 outputs 0 indicating False. For example, in the case of the explanatory condition, since the corrected D01 request power is 150 W and V0 allowable power×½ is 140 W, the comparator 121 outputs 1.

The subtractor 140 receives the input of the V0 allowable power output from the selector 127. In addition, the subtractor 140 receives the input of the corrected D01 request power output from the multiplexer 131. Next, the subtractor 140 outputs a value obtained by subtracting the corrected D01 request power from the V0 allowable power. For example, in the case of the explanatory condition, since the V0 allowable power is 280 W and the corrected D01 request power is 150 W, the subtractor 140 outputs 130 W.

The comparator 146 receives the input of the corrected D00 request power output from the multiplexer 129. In addition, the comparator 146 receives an input of a value obtained by subtracting the corrected D01 request power from the V0 allowable power output from the subtractor 140. Next, the comparator 146 compares the corrected D00 request power with a value obtained by subtracting the corrected D01 request power from the V0 allowable power. When the corrected D00 request power is larger than a value obtained by subtracting the corrected D01 request power from the V0 allowable power, the comparator 146 outputs 1 indicating True. In addition, the comparator 146 outputs 0 indicating False when the corrected D00 request power is equal to or less than a value obtained by subtracting the corrected D01 request power from the V0 allowable power. For example, in the case of the explanatory condition, since the corrected D00 request power is 130 W and the value obtained by subtracting the corrected D01 request power from the V0 allowable power is 130 W, the comparator 121 outputs 0.

The comparator 147 receives the input of the corrected D01 request power output from the multiplexer 131. In addition, the comparator 147 receives an input of a value obtained by subtracting the corrected D00 request power from the V0 allowable power output from the subtractor 138. Next, the comparator 147 compares the corrected D01 request power with a value obtained by subtracting the corrected D00 request power from the V0 allowable power. When the corrected D01 request power is larger than a value obtained by subtracting the corrected D00 request power from the V0 allowable power, the comparator 147 outputs 1 indicating True. In addition, the comparator 147 outputs 0 indicating False when the corrected D01 request power is equal to or less than a value obtained by subtracting the corrected D00 request power from the V0 allowable power. For example, in the case of the explanatory condition, since the corrected D01 request power is 150 W and the value obtained by subtracting the corrected D00 request power from the V0 allowable power is 150 W, the comparator 121 outputs 0.

The selector 148 receives the input of the half value of the VRM allowable power output from the divider 136, the corrected D00 request power output from the multiplexer 129, and the corrected D01 request power output from the multiplexer 131. In addition, the selector 148 receives inputs of an output value of the comparator 137, an output value of the comparator 139, an output value of the comparator 146, and an output value of the comparator 147.

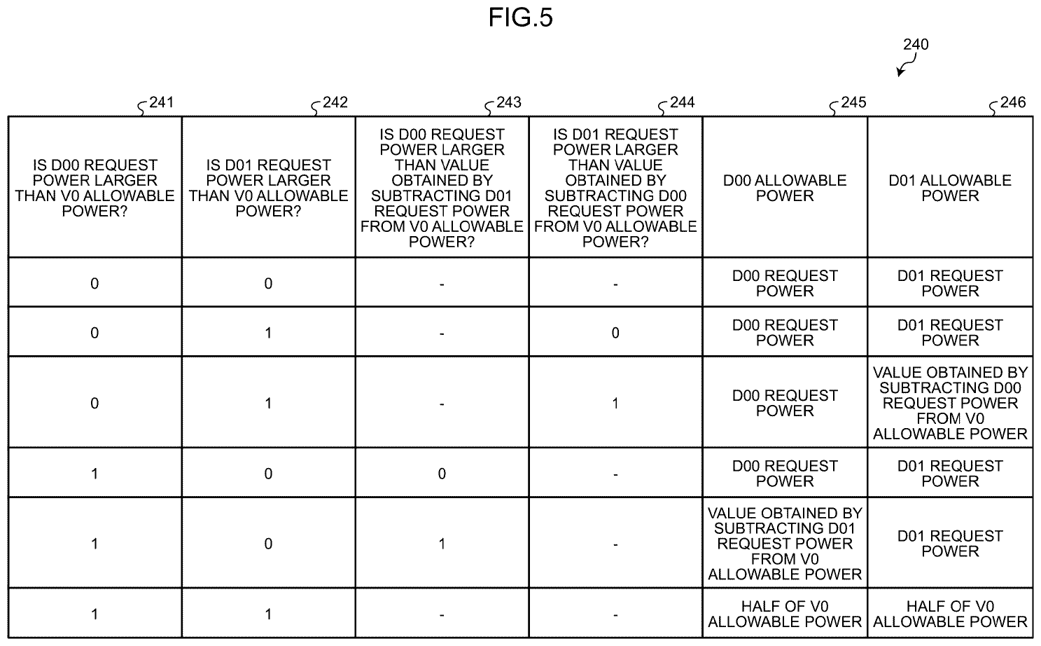

FIG. 5 is a diagram illustrating a die unit allowable power determination table. In a die unit allowable power determination table 240, a column 241 indicates an output value of the comparator 137. In addition, a column 242 indicates an output value of the comparator 139. In addition, a column 243 indicates an output value of the comparator 146. In addition, a column 244 indicates an output value of the comparator 147. A column 245 corresponds to the D00 allowable power output from the selector 148. A column 246 corresponds to the D01 allowable power output from the selector 148.

The selector 148 includes the die unit allowable power determination table 240 illustrated in FIG. 5. The selector 148 determines data to be selected according to the die unit allowable power determination table 240 based on the output value of the comparator 137, the output value of the comparator 139, the output value of the comparator 146, and the output value of the comparator 147. Then, the selector 148 outputs the information selected as the D00 allowable power and the D01 allowable power. For example, in the case of the explanatory condition, since the output values of the comparators 137, 139, 146, and 147 are 0, 1, 0, and 0, respectively, the selector 127 outputs 130 W as the D00 allowable power and outputs 150 W as the D01 allowable power.

The divider 141, the comparator 142, the subtractor 143, the comparator 144, the subtractor 145, the comparator 149, the comparator 150, and the selector 151 similarly determine the D10 allowable power and the D11 allowable power. For example, in the case of the explanatory condition, the divider 141 outputs 175 W. The comparator 142 outputs 1. The subtractor 143 outputs 170 W, and the comparator 144 outputs 1. The subtractor 145 outputs 150 W. The comparator 149 outputs 1. The comparator 150 outputs 1. Since the output values of the comparators 142, 144, 149, and 150 are 1, 1, 1, and 1, respectively, the selector 151 outputs 175 W as the D10 allowable power and outputs 175 W as the D11 allowable power.

Returning to FIG. 2, the description will be continued. The transmission unit 107 is an interface for transmitting information. The transmission unit 107 receives the D00 allowable power, the D01 allowable power, the D10 allowable power, and the D11 allowable power from the die unit allowable power determination unit 106. Then, the transmission unit 107 transmits the D00 allowable power to the power control circuit 300 of the CPU core die D00. The transmission unit 107 transmits the D01 allowable power to the power control circuit 301 of the CPU core die D01. The transmission unit 107 transmits the D10 allowable power to the power control circuit 310 of the CPU core die D10. The transmission unit 107 transmits the D11 allowable power to the power control circuit 311 of the CPU core die D11.

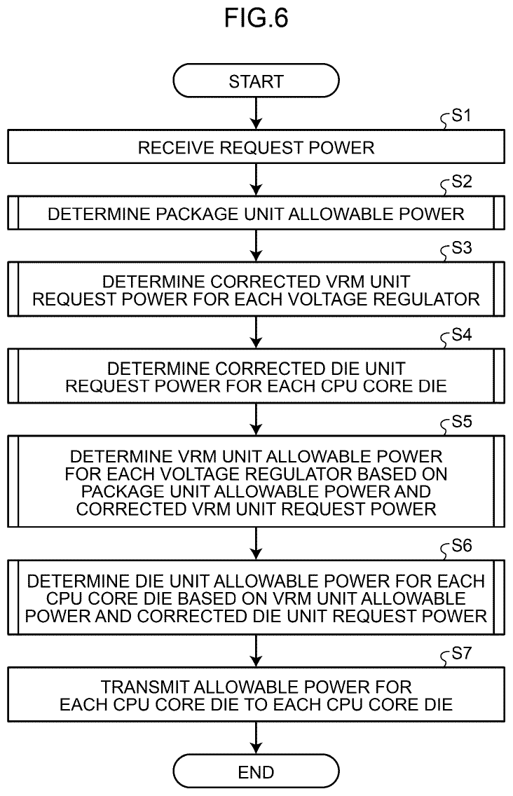

FIG. 6 is a flowchart of allowable power adjustment processing by the allowable power adjustment circuit according to the first embodiment. Next, an overall flow of allowable power adjustment processing by the allowable power adjustment circuit 100 according to the first embodiment will be described with reference to FIG. 6.

The information reception unit 101 receives the D00 request power, the D01 request power, the D10 request power, and the D11 request power, which are the respective die unit request powers, from the CPU core die D00, the CPU core die D01, the CPU core die D10, and the CPU core die D11 (Step S1).

The package unit allowable power determination unit 102 determines the package unit allowable power using the D00 request power, the D01 request power, the D10 request power, the D11 request power, and the package unit power limit (Step S2).

The corrected VRM unit request power determination unit 103 determines the corrected VRM unit request power for each of the voltage regulators V0 and V1 using the die unit request power and the VRM unit power limit (Step S3). Specifically, the corrected VRM unit request power determination unit 103 determines the corrected V0 request power and the corrected V1 request power.

The corrected die unit request power determination unit 104 determines the corrected die unit request power for each of the CPU core die D00, the CPU core die D01, the CPU core die D10, and the CPU core die D11 using the die unit request power and the die unit power limit (Step S4). Specifically, the corrected die unit request power determination unit 104 determines the corrected D00 request power, the corrected D01 request power, the corrected D10 request power, and the corrected D11 request power.

The VRM unit allowable power determination unit 105 determines the VRM unit allowable power for each of the voltage regulators V0 and V1 based on the package unit allowable power and the corrected VRM unit request power (Step S5). Specifically, the VRM unit allowable power determination unit 105 determines the V0 allowable power and the V1 allowable power.

The die unit allowable power determination unit 106 determines the die unit allowable power for each of the CPU core die D00, the CPU core die D01, the CPU core die D10, and the CPU core die D11 based on the VRM unit allowable power and the corrected die unit request power (Step S6). Specifically, the die unit allowable power determination unit 106 determines the D00 allowable power, the D01 allowable power, the D10 allowable power, and the D11 allowable power.

The transmission unit 107 transmits the D00 allowable power, the D01 allowable power, the D10 allowable power, and the D11 allowable power to the CPU core die D00, the CPU core die D01, the CPU core die D10, and the CPU core die D11, respectively (Step S7).

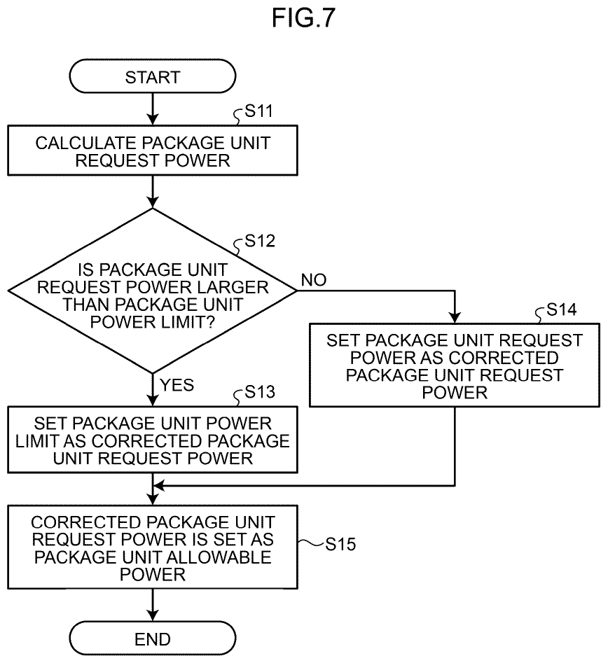

FIG. 7 is a flowchart of determination processing of package unit allowable power. Next, a flow of determination processing of the package unit allowable power by the package unit allowable power determination unit 102 will be described with reference to FIG. 7. Each processing illustrated in the flow of FIG. 7 corresponds to an example of processing executed in Step S2 in FIG. 6.

The package unit allowable power determination unit 102 calculates the package unit allowable power by summing the D00 request power, the D01 request power, the D10 request power, and the D11 request power (Step S11).

Next, the package unit allowable power determination unit 102 determines whether the calculated package unit request power is larger than the package unit power limit (Step S12).

When the package unit request power is larger than the package unit power limit (Step S12: Yes), the package unit allowable power determination unit 102 sets the package unit power limit as corrected package unit request power (Step S13).

On the other hand, when the package unit request power is equal to or less than the package unit power limit (Step S12: yes), the package unit allowable power determination unit 102 sets the package unit request power as corrected package unit request power (Step S14).

Next, the package unit allowable power determination unit 102 sets the corrected package unit request power as the package unit allowable power (Step S15).

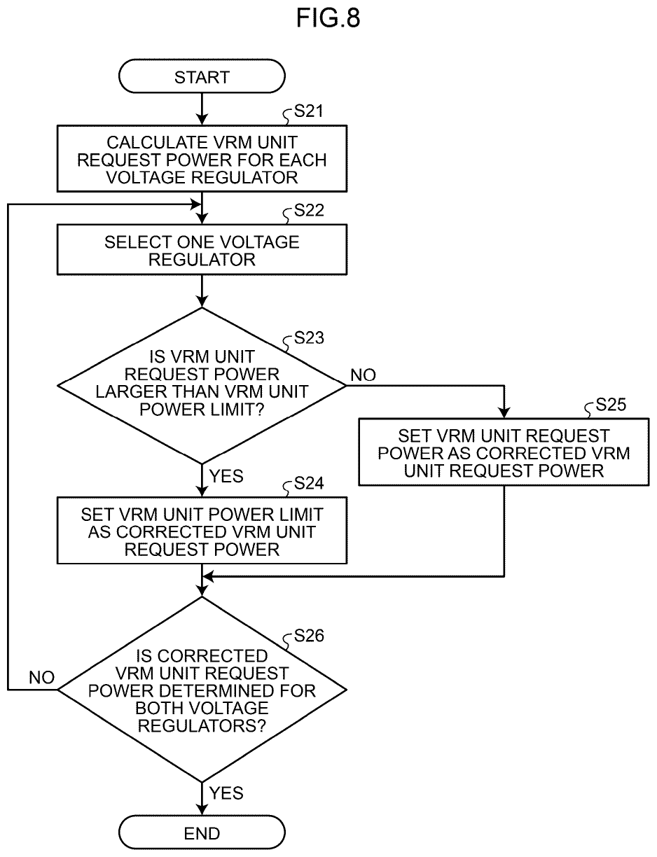

FIG. 8 is a flowchart of determination processing of corrected VRM unit request power. Next, a flow of determination processing of the corrected VRM unit request power by the corrected VRM unit request power determination unit 103 will be described with reference to FIG. 8. Each processing illustrated in the flow of FIG. 8 corresponds to an example of processing executed in Step S3 in FIG. 6.

The corrected VRM unit request power determination unit 103 calculates the VRM unit request power for each of the voltage regulators V0 and V1. Specifically, the corrected VRM unit request power determination unit 103 calculates the V0 unit request power by summing the D00 request power and the D01 request power. The corrected VRM unit request power determination unit 103 calculates the V1 unit request power by summing the D10 request power and the D11 request power (Step S21).

Next, the corrected VRM unit request power determination unit 103 selects one of the voltage regulators V0 and V1 (Step S22). The corrected VRM unit request power determination unit 103 performs the following processing for the selected one of the voltage regulators V0 and V1.

Next, the corrected VRM unit request power determination unit 103 determines whether the VRM unit request power is larger than the VRM unit power limit for the selected voltage regulator V0 or V1 (Step S23).

When the VRM unit request power is larger than the VRM unit power limit (Step S23: Yes), the corrected VRM unit request power determination unit 103 sets the VRM unit power limit as the corrected VRM unit request power (Step S24).

On the other hand, when the VRM unit request power is equal to or less than the VRM unit power limit (Step S23: No), the corrected VRM unit request power determination unit 103 sets the VRM unit request power as the corrected VRM unit request power (Step S25).

Thereafter, the corrected VRM unit request power determination unit 103 determines whether the corrected VRM unit request power is determined for both the voltage regulators V0 and V1 (Step S26).

When the corrected VRM unit request power of either of the voltage regulators V0 and V1 is not determined (Step S26: No), the corrected VRM unit request power determination unit 103 returns to Step S22. On the other hand, when the corrected VRM unit request power is determined for both the voltage regulators V0 and V1 (Step S26: Yes), the corrected VRM unit request power determination unit 103 ends the determination processing of the corrected VRM unit request power.

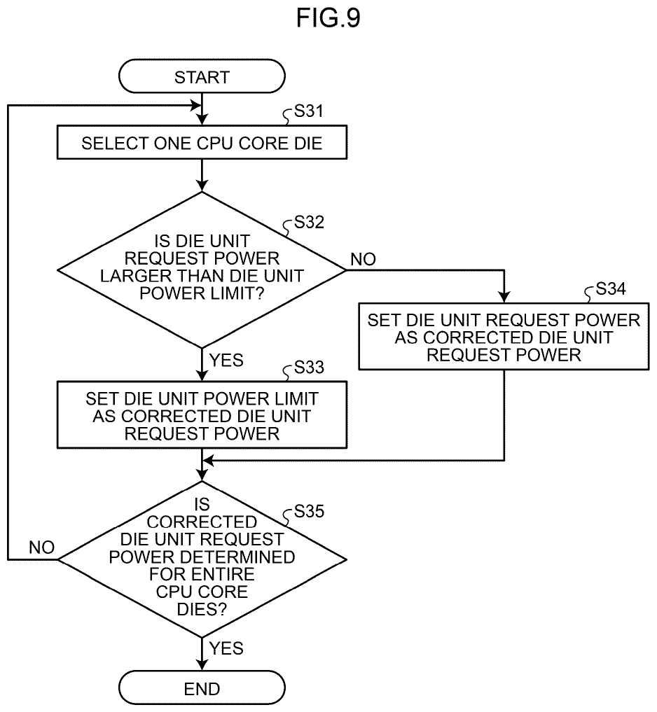

FIG. 9 is a flowchart of determination processing of the corrected die unit request power. Next, a flow of determination processing of the corrected die unit request power by the corrected die unit request power determination unit 104 will be described with reference to FIG. 9. Each processing illustrated in the flow of FIG. 9 corresponds to an example of processing executed in Step S4 in FIG. 6.

The corrected die unit request power determination unit 104 selects any one of the CPU core dies D00, D01, D10, and D11 (Step S31). The corrected die unit request power determination unit 104 performs the following processing for one selected from the CPU core dies D00, D01, D10, and D11.

Next, the corrected die unit request power determination unit 104 determines whether the die unit request power is larger than the die unit power limit (Step S32).

When the die unit request power is larger than the die unit power limit (Step S32: Yes), the corrected die unit request power determination unit 104 sets the die unit power limit as the corrected die unit request power (Step S33).

On the other hand, when the die unit request power is equal to or less than the die unit power limit (Step S23: No), the corrected die unit request power determination unit 104 sets the die unit request power as the corrected die unit request power (Step S34).

Thereafter, the corrected die unit request power determination unit 104 determines whether or not the corrected die unit request power has been determined for all of the CPU core dies D00, D01, D10, and D11 (Step S35).

When the determination of the corrected die unit request power of any one of the CPU core dies D00, D01, D10, and D11 remains (Step S35: No), the corrected die unit request power determination unit 104 returns to Step S31. On the other hand, when the corrected die unit request power is determined for all of the CPU core dies D00, D01, D10, and D11 (Step S35: Yes), the corrected die unit request power determination unit 104 ends the determination processing of the corrected die unit request power.

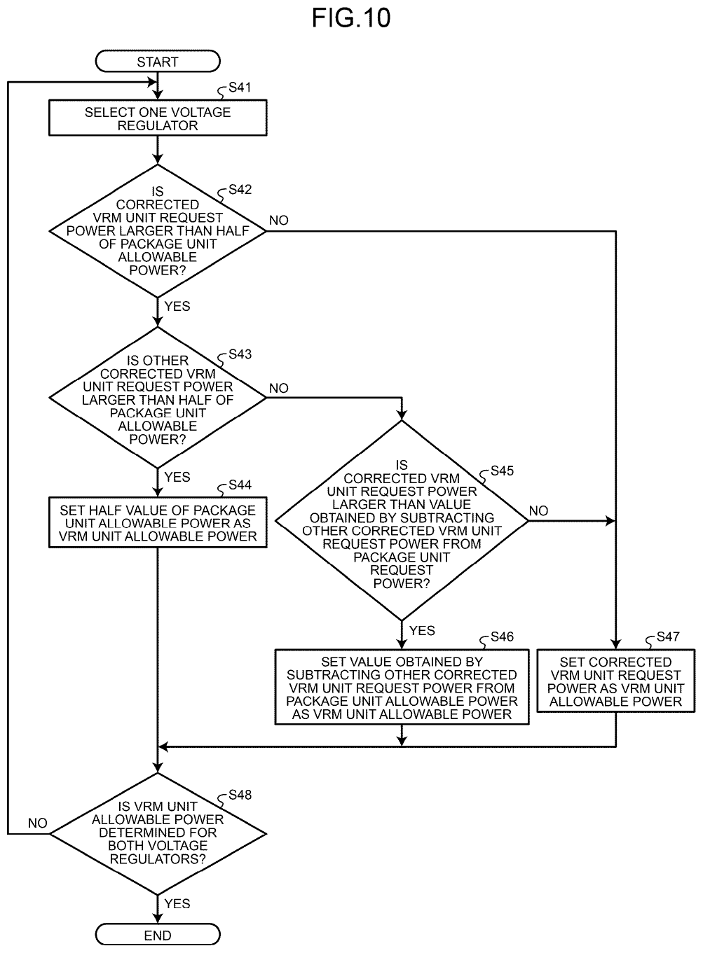

FIG. 10 is a flowchart of determination processing of VRM unit allowable power. Next, a flow of determination processing of the VRM unit allowable power by the VRM unit allowable power determination unit 105 will be described with reference to FIG. 10. Each processing illustrated in the flow of FIG. 10 corresponds to an example of processing executed in Step S5 in FIG. 6.

The VRM unit allowable power determination unit 105 selects one of the voltage regulators V0 and V1 (Step S41). The VRM unit allowable power determination unit 105 performs the following processing for one selected from the voltage regulators V0 and V1.

The VRM unit allowable power determination unit 105 determines whether the corrected VRM unit request power is larger than half of the package unit allowable power (Step S42).

When the corrected VRM unit request power is larger than half of the package unit allowable power (Step S42: Yes), the VRM unit allowable power determination unit 105 determines whether the other corrected VRM request power is larger than half of the package unit allowable power (Step S43). Here, the other corrected VRM request power is the corrected VRM unit request power on the unselected side of the voltage regulator V0 or V1.

When the other corrected VRM request power is larger than half of the package unit allowable power (Step S43: Yes), the VRM unit allowable power determination unit 105 sets the VRM unit allowable power to half of the package unit allowable power (Step S44).

On the other hand, when the other corrected VRM request power is half or less of the package unit allowable power (Step S43: No), the VRM unit allowable power determination unit 105 calculates a value obtained by subtracting the other corrected VRM request power from the package unit allowable power. Then, the VRM unit allowable power determination unit 105 determines whether the corrected VRM unit request power is larger than a value obtained by subtracting the other corrected VRM request power from the package unit allowable power (Step S45). When the value obtained by subtracting the corrected V1 request power from the package unit allowable power is larger than the corrected V0 request power (Step S45: Yes), the VRM unit allowable power determination unit 105 performs the following processing. That is, the VRM unit allowable power determination unit 105 sets the VRM unit allowable power to a value obtained by subtracting the other corrected VRM unit request power from the package unit allowable power (Step S46).

On the other hand, when the value obtained by subtracting the corrected V1 request power from the package unit allowable power is equal to or less than the corrected V0 request power (Step S45: No), the VRM unit allowable power determination unit 105 sets the corrected VRM unit request power as the VRM unit allowable power (Step S47). When the corrected VRM unit request power is half or less of the package unit allowable power (Step S42: No), the VRM unit allowable power determination unit 105 sets the corrected VRM unit request power as the VRM unit allowable power (Step S47).

Thereafter, the VRM unit allowable power determination unit 105 determines whether the VRM unit allowable power has been determined for both the voltage regulators V0 and V1 (Step S48).

When the VRM unit allowable power of either of the voltage regulators V0 and V1 is not determined (Step S48: No), the VRM unit allowable power determination unit 105 returns to Step S41. On the other hand, when the VRM unit allowable power is determined for both the voltage regulators V0 and V1 (Step S48: Yes), the VRM unit allowable power determination unit 105 ends the determination processing of the VRM unit allowable power.

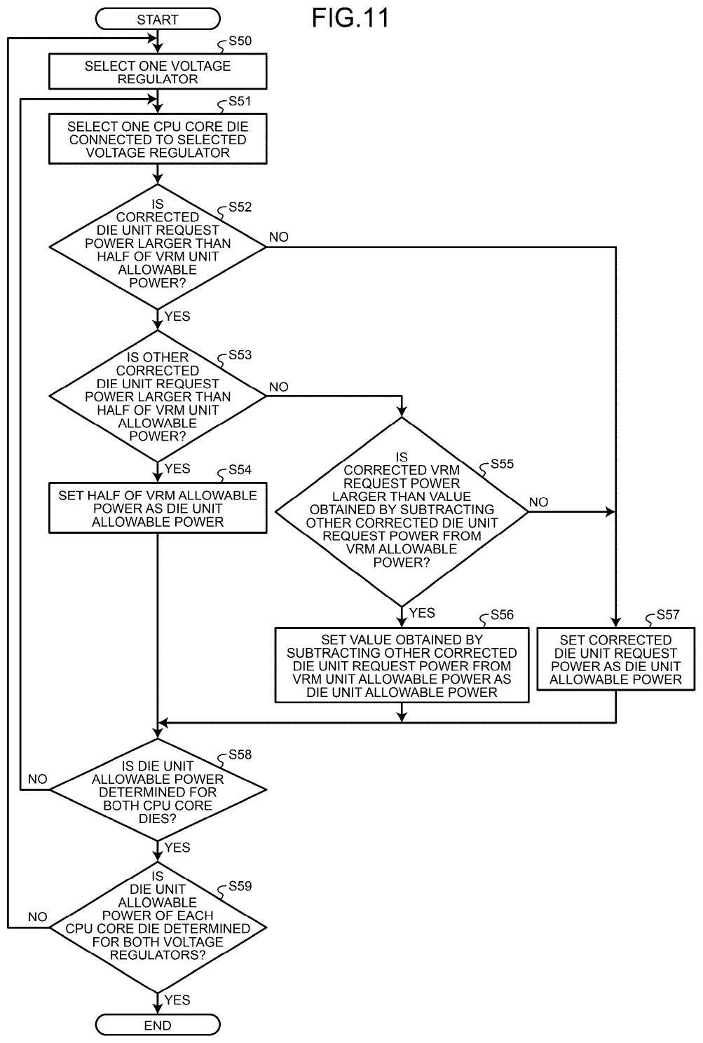

FIG. 11 is a flowchart of determination processing of die unit allowable power. Next, a flow of determination processing of the VRM unit allowable power by the die unit allowable power determination unit 106 will be described with reference to FIG. 11. Each processing illustrated in the flow of FIG. 11 corresponds to an example of processing executed in Step S6 in FIG. 6.

The die unit allowable power determination unit 106 selects one of the voltage regulators V0 and V1 (Step S50). The die unit allowable power determination unit 106 performs the following processing for one selected from the voltage regulators V0 and V1.

Next, the die unit allowable power determination unit 106 selects one of the CPU core dies D00 and D10 or the CPU core dies D10 and D11 connected to the selected voltage regulator V0 or V1 (Step S51). The die unit allowable power determination unit 106 performs the following processing for one selected from the CPU core dies D00, D01, D10, and D11.

Next, the die unit allowable power determination unit 106 determines whether the corrected die unit request power is larger than half of the VRM unit allowable power (Step S52).

When the corrected die unit request power is larger than half of the VRM unit allowable power (Step S52: Yes), the die unit allowable power determination unit 106 determines whether the other corrected die unit request power is larger than half of the VRM allowable power (Step S53). The other corrected die unit request power is a CPU core die D00 and D01 or a CPU core die opposite to the selected one of the CPU core dies D10 and D11.

When the other corrected die unit request power is larger than half of the VRM allowable power (Step S53: Yes), the die unit allowable power determination unit 106 sets the die unit allowable power to half of the VRM allowable power (Step S54).

On the other hand, when the corrected die unit request power is half or less than the VRM allowable power (Step S53: No), the die unit allowable power determination unit 106 performs the following processing. That is, the die unit allowable power determination unit 106 determines whether the corrected VRM request power is larger than a value obtained by subtracting the other corrected die unit request power from the VRM allowable power (Step S55).

When the corrected VRM request power is larger than a value obtained by subtracting the other corrected die unit request power from the VRM allowable power (Step S55: Yes), the die unit allowable power determination unit 106 performs the following processing. That is, the die unit allowable power determination unit 106 sets a value obtained by subtracting the other corrected die unit request power from the VRM allowable power as the die unit allowable power (Step S56). Here, the other corrected die unit request power is the CPU core dies D00 and D01 connected to the selected voltage regulator V0 or V1, or the corrected die unit request power on the unselected side of the CPU core dies D10 and D11.

On the other hand, when the corrected VRM request power is equal to or less than the value obtained by subtracting the other corrected die unit request power from the VRM allowable power (Step S55: No), the die unit allowable power determination unit 106 sets the corrected die unit request power as the die unit allowable power (Step S57). When the corrected die unit request power is half or less of the VRM unit allowable power (Step S52: No), the die unit allowable power determination unit 106 sets the corrected die unit request power as the die unit allowable power (Step S57).

Thereafter, the die unit allowable power determination unit 106 determines whether the die unit allowable power has been determined for all of the CPU core dies D00 and D01 or the CPU core dies D10 or D11 connected to the selected voltage regulator V0 or V1 (Step S58). When the determination of the die unit allowable power remains (Step S58: No), the die unit allowable power determination unit 106 returns to Step S51.

When the die unit allowable power is determined for all of the CPU core dies D00 and D01 or the CPU core die D10 or D11 connected to the selected voltage regulator V0 or V1 (Step S58: Yes), the die unit allowable power determination unit 106 performs the following processing. That is, the die unit allowable power determination unit 106 determines whether or not all the die unit allowable power has been determined for both the voltage regulators V0 and V1 (Step S59).

When the determination of the die unit allowable power remains for any of the voltage regulators V0 and V1 (Step S59: No), the die unit allowable power determination unit 106 returns to Step S50. On the other hand, when all the die unit allowable powers have been determined for both the voltage regulators V0 and V1 (Step S59: Yes), the die unit allowable power determination unit 106 ends the determination processing of the die unit allowable power.

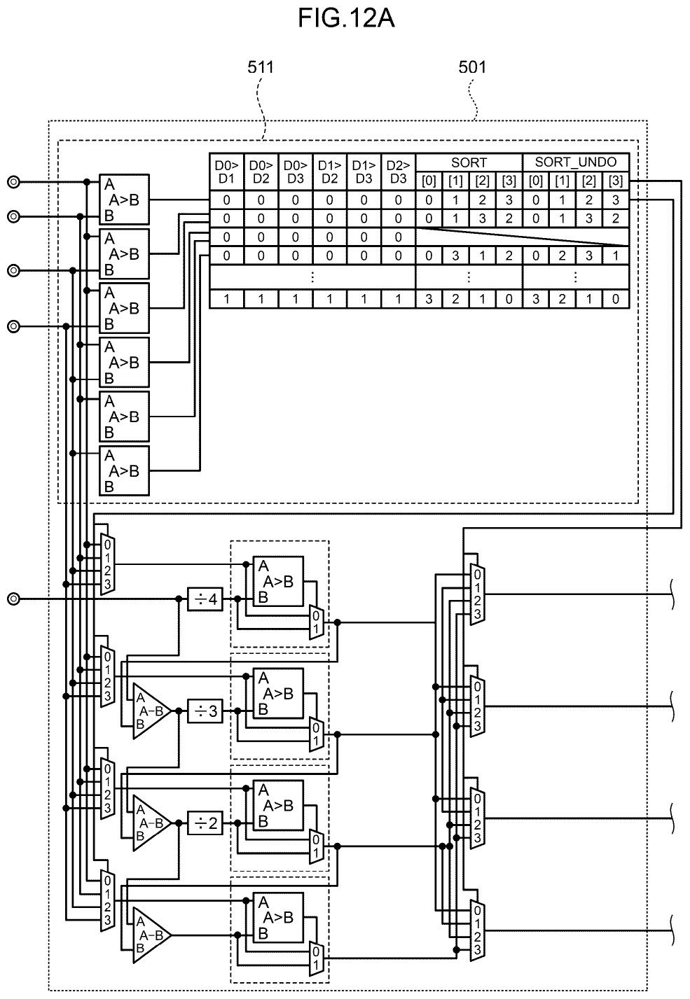

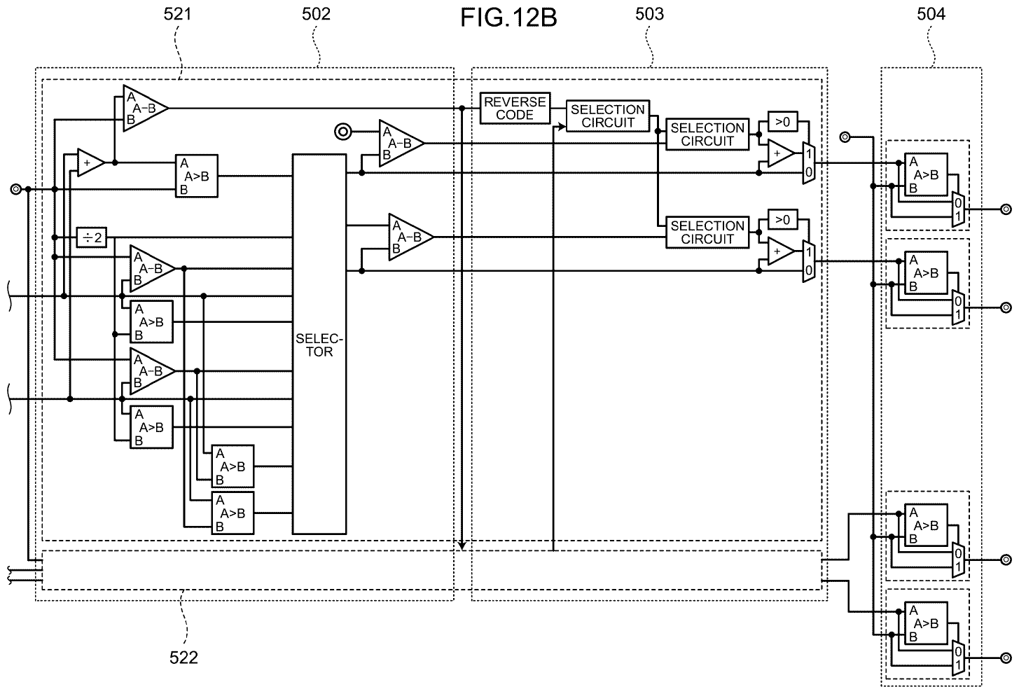

FIG. 12 is a diagram illustrating an example of a circuit in a case where strict equal allocation is performed. For example, when power is strictly equally allocated to each of the CPU core dies D00, D01, D10, and D11, a circuit as illustrated in FIG. 12 is used. In this case, for example, a first circuit 501, a second circuit 502, a third circuit 503, and a fourth circuit 504 are provided.

The first circuit 501 includes a sort circuit 511. The sort circuit 511 is a circuit that sorts the die unit request power in ascending order, and the circuit scale increases according to the number of CPU core dies. In addition, a circuit 521 and a circuit 522 included in the second circuit 502 and the third circuit 503 have the same circuit configuration. In addition, the selection circuit of the third circuit 503 is a circuit that selects a small value among the two input values.

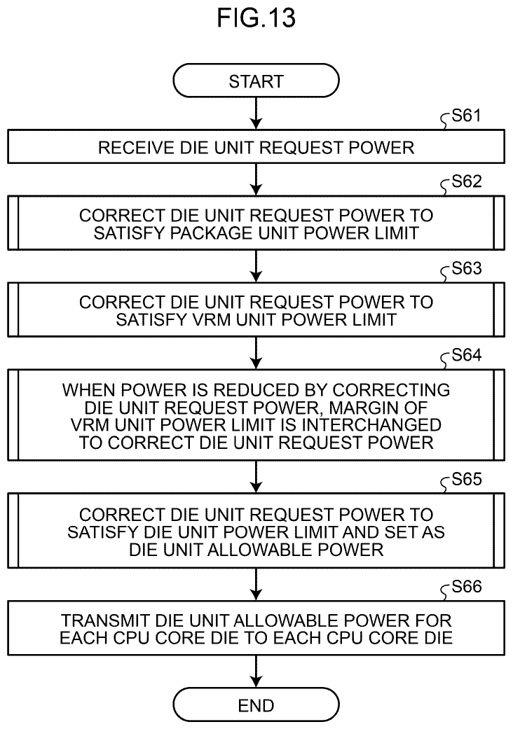

FIG. 13 is a flowchart of the determination processing of the die unit allowable power in a case where strict equal allocation is performed. For example, the first circuit 501 receives the die unit request power from each of the CPU core dies D00, D01, D10, and D11 (Step S61).

Next, the first circuit 501 uses the sort circuit 511 to generate an intermediate signal using a table from the comparison result of each die unit request signal, and uses the intermediate signal to generate the ascending die unit request power. Then, the first circuit 501 compares the first lowest ascending die unit request power with ¼ of the package unit power limit, and corrects the first lowest ascending die unit request power. Next, the first circuit 501 compares the second lowest ascending die unit request power with ⅓ of the value obtained by subtracting the first lowest ascending die unit request power corrected from the package unit power limit, and corrects the second lowest ascending die unit request power. Next, the first circuit 501 compares the third lowest ascending die unit request power with ½ of the value obtained by subtracting the first and second lowest ascending die unit request power corrected from the package unit power limit, and corrects the third lowest ascending die unit request power. Next, the first circuit 501 compares the fourth lowest ascending die unit request power with the value obtained by subtracting the first to third lowest ascending die unit request power corrected from the package unit power limit, and corrects the fourth lowest ascending die unit request power. As a result, the first circuit 501 corrects each die unit request power so as to satisfy the package unit power limit (Step S62).

The second circuit 502 calculates each VRM unit request power from the die unit request power from each of the CPU core dies D00, D01, D10, and D11. Then, the second circuit 502 corrects the die unit request power using the VRM unit power limit and each VRM unit request power for each of the voltage regulators V0 and V1 so as to satisfy the VRM unit power limit (Step S63).

The third circuit 503 calculates an excess of each VRM unit power with respect to the VRM unit power limit. When the power is reduced by any one of the voltage regulators V0 and V1 by the correction of the die unit request power, the third circuit 503 corrects the die unit request power of any one of the voltage regulators V0 and V1 from the side where there is a margin in the VRM unit power limit (Step S64).

The fourth circuit 504 corrects each die unit request power so as to satisfy the die unit power limit, and sets the corrected value as the die unit allowable power (Step S65).

Thereafter, the fourth circuit 504 transmits the die unit allowable power for each of the CPU core dies D00, D01, D10, and D11 to each of the CPU core dies D00, D01, D10, and D11 (Step S66).

Here, the first circuit 501 increases in proportion to the number of CPU core dies. In addition, the first circuit 501 includes a divider or the like for dividing by 3, and division by 2 or division by 4 is calculated by a rightward shift of 1 bit or 2 bits, but division by 3 increases the circuit to some extent. Therefore, the circuit scale of the first circuit 501 is increased. Then, since the circuit scale of the first circuit 501 is increased, in a case where strict equal allocation of power is performed, the circuit scale is increased and the circuit complexity is also increased. In comparison, as in the circuit configuration illustrated in FIG. 3, the allowable power adjustment circuit 100 according to the present embodiment does not use the sort circuit or the divider divided by 3, so that the circuit scale is suppressed.

As described above, the allowable power adjustment circuit according to the present embodiment sets the smaller one of the power limit and the request power as the allowable power for the package unit allowable power, the allowable power for the die group unit connected to the voltage regulator, and the die unit allowable power. As described above, by determining the allowable power by performing approximately equal allocation without strictly equal allocation of the allowable power, it is possible to reduce the circuit scale and reduce an increase in the circuit scale and an increase in the circuit complexity when the number of CPU core dies increases.

### [b] Second Embodiment

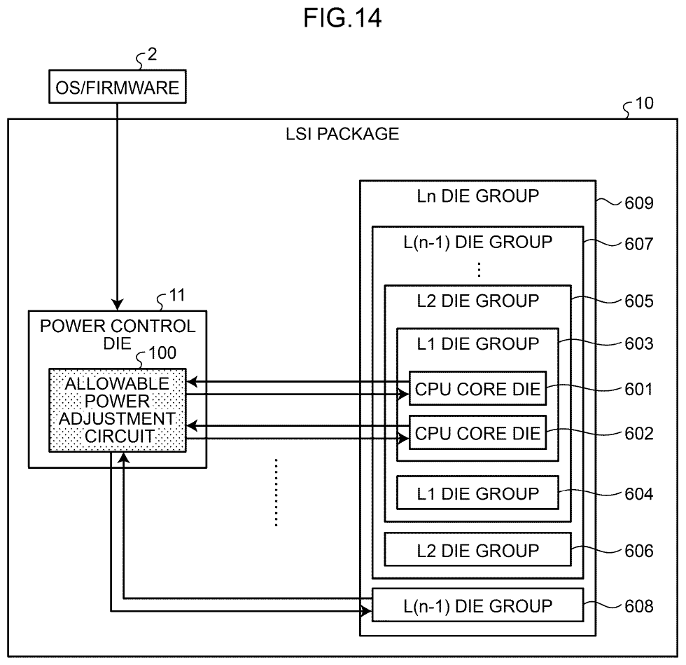

FIG. 14 is a hardware configuration diagram according to a second embodiment. The LSI package 10 according to the present embodiment mounts a plurality of CPU core dies including CPU core dies 601 and 602. Here, when the plurality of CPU core dies mounted on the LSI package 10 are not distinguished from one another, they are referred to as the CPU core dies 600.

Further, an L1 die group 603 includes the CPU core dies 601 and 602. The L1 die group 603 is a die group in one level up from the CPU core dies 601 and 602. Further, an L1 die group 604 includes two CPU core dies 600 similarly to the L1 die group 603.

An L2 die group 605 includes the L1 die groups 603 and 604. That is, the L2 die group 605 includes four CPU core dies 600. An L2 die group 606 has the same structure as the L2 die group 605 and includes four CPU core dies 600.

Similarly, the L2 die group 605 in one level down includes the L1 die groups 603 and 604. That is, the L2 die group 605 includes four CPU core dies 600. The L2 die group 605 is a die group in one level up from the L1 die groups 603 and 604. The L2 die group 606 has the same structure as the L2 die group 605 and includes four CPU core dies 600.

As described above, the Li die group is a die group in one level up from the L(i−1) die group including two L(i−1) die groups. The Li die group includes 2\hat{ }i CPU core dies 600. Here, 2\hat{ }i represents 2 raised to the i-th power. The LSI package 10 includes an Ln die group 609 including L(n−1) die groups 607 and 608 as the largest die group. The Ln die group 609 includes 2\hat{ }n CPU core dies 600.

Each of the 2\hat{ }i CPU core dies 600 is connected to the allowable power adjustment circuit 100. The 2\hat{ }i CPU core dies 600 are driven by receiving power supplied from one voltage regulator (not illustrated). Hereinafter, the layer of the CPU core die 600 is referred to as an L0 layer, and the layer of the Li die group is referred to as a Li layer.

That is, in the plurality of CPU core dies 600, a group having a layer structure including a plurality of groups in the layer one level down is formed with each CPU core die 600 as the lowest group.

The allowable power adjustment circuit 100 receives, from the OS/Firmware 2, the Li layer power limit at a die group unit for each die group in the L0 to Ln layers. The allowable power adjustment circuit 100 receives the die unit request power of each of the 2\hat{ }i CPU core dies 600. Then, the allowable power adjustment circuit 100 determines the die unit allowable power of each of the 2\hat{ }i CPU core dies 600 using the die unit request power, the die unit power limit, and the Li layer unit power limit. Here, the die unit request power is the L0 layer request power. In addition, the die unit power limit is an L0 layer power limit. In addition, the die unit allowable power is the L0 layer allowable power.

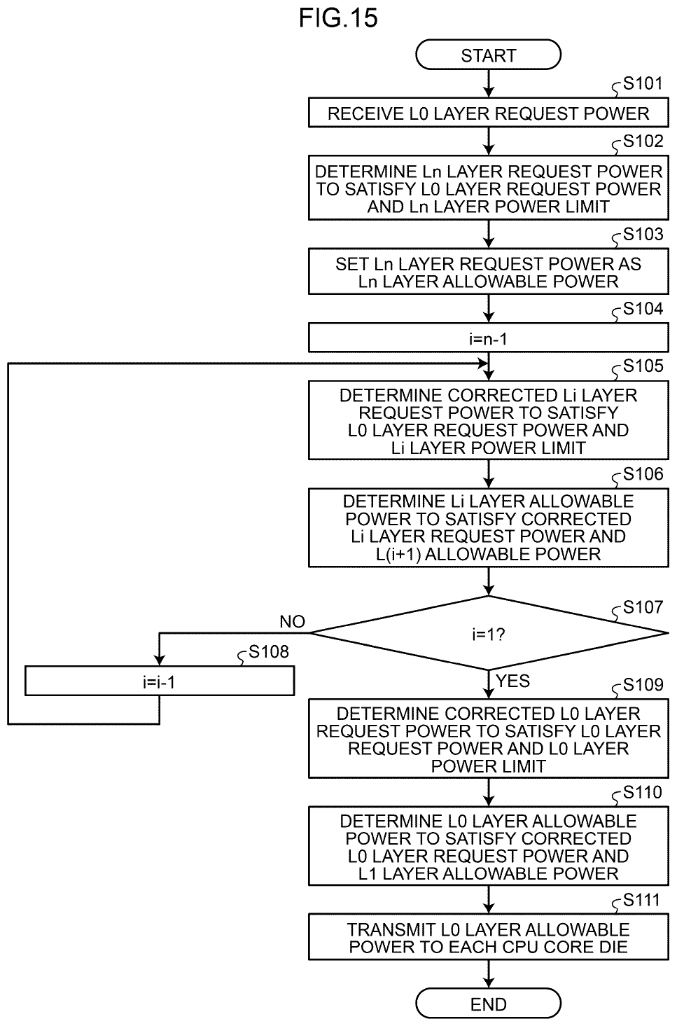

FIG. 15 is a flowchart of allowable power adjustment processing by the allowable power adjustment circuit according to the second embodiment. Hereinafter, allowable power adjustment processing by the allowable power adjustment circuit 100 according to the second embodiment will be described with reference to FIG. 15. The allowable power adjustment circuit 100 according to the present embodiment is also illustrated by the block diagram of FIG. 2.

The package unit allowable power determination unit 102 receives the die unit request power of each of the 2\hat{ }i CPU core dies 600, in other words, the L0 layer request power (Step S101).

Next, the package unit allowable power determination unit 102 determines the Ln layer request power so as to satisfy the L0 layer request power and the Ln layer power limit (Step S102).

Next, the package unit allowable power determination unit 102 sets the determined Ln layer request power as the Ln layer allowable power (Step S103). Here, the Ln die group 609 includes all the CPU core die 600 included in the LSI package 10, and the Ln layer allowable power coincides with the package allowable power.

The corrected die unit request power determination unit 104 sets i=n−1 (Step S104).

Next, the corrected die unit request power determination unit 104 determines the corrected Li layer request power so as to satisfy the L0 layer request power and the Li layer power limit (Step S105).

Next, the corrected die unit request power determination unit 104 determines the Li layer allowable power so as to satisfy the corrected Li layer request power and the L(i+1) layer allowable power (Step S106).

Next, the corrected die unit request power determination unit 104 determines whether i=1 (Step S107). In a case where i=1 is not satisfied (Step S107: No), the corrected die unit request power determination unit 104 decrements i by one (Step S108). Thereafter, the corrected die unit request power determination unit 104 returns to Step S105.

On the other hand, when i=n−1 (Step S107: Yes), the corrected die unit request power determination unit 104 determines the corrected L0 layer request power so as to satisfy the L0 layer request power and the L0 layer power limit (Step S109).

Next, the die unit allowable power determination unit 106 determines the L0 layer allowable power so as to satisfy the L0 layer request power and the L1 layer allowable power (Step S110).

Thereafter, the die unit allowable power determination unit 106 transmits each L0 layer allowable power to each CPU core die 600 (Step S111).

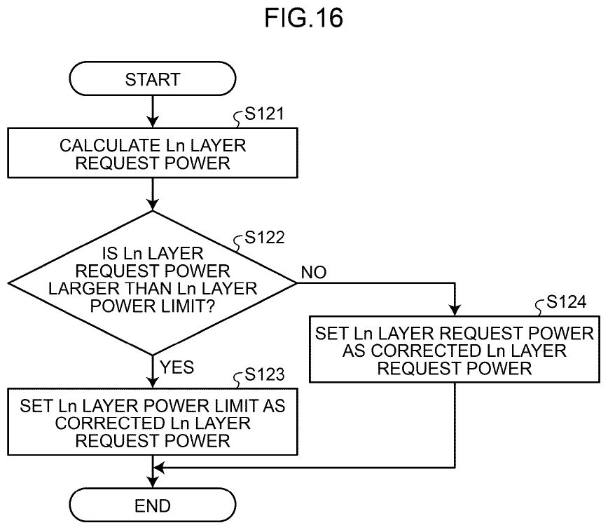

FIG. 16 is a flowchart of determination processing the corrected Ln layer request power. Each processing performed in the flow of FIG. 16 corresponds to an example of the processing performed in Step S102 in FIG. 15.

The package unit allowable power determination unit 102 calculates the Ln layer request power by summing the die unit request power of each of the 2\hat{ }n CPU core dies 600 (Step S121).

Next, the package unit allowable power determination unit 102 determines whether the Ln layer request power is larger than the Ln layer power limit (Step S122).

When the Ln layer request power is larger than the Ln layer power limit (Step S122: Yes), the package unit allowable power determination unit 102 sets the Ln layer power limit as the corrected Ln layer request power (Step S123).

On the other hand, when the Ln layer request power is equal to or less than the Ln layer power limit (Step S122: No), the package unit allowable power determination unit 102 sets the Ln layer request power as the corrected Ln layer request power (Step S124).

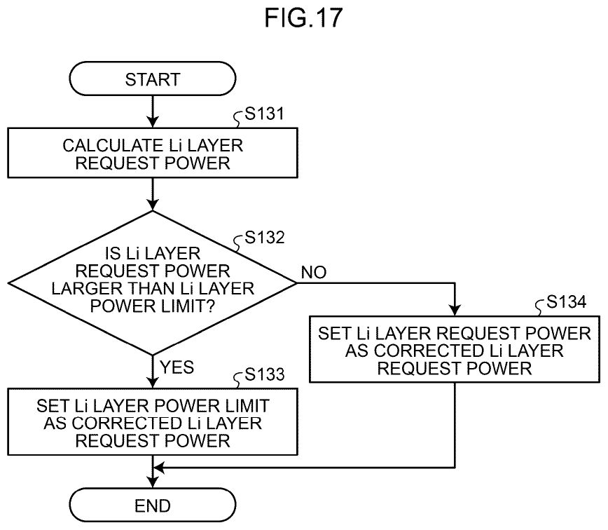

FIG. 17 is a flowchart of determination processing of corrected Li layer request power. Each processing performed in the flow of FIG. 17 corresponds to an example of the processing performed in Step S105 in FIG. 15. Here, since there are 2\hat{ }(n+1−i) Li die groups, the processing described below is performed for each of the 2\hat{ }(n+1−i) Li die groups.

The corrected die unit request power determination unit 104 calculates the Li layer request power by summing the die unit request power of each of the CPU core dies 600 included in the Li die group (Step S131).

Next, the corrected die unit request power determination unit 104 determines whether the Li layer request power is larger than the Li layer power limit (Step S132).

When the Li layer request power is larger than the Li layer power limit (Step S132: Yes), the corrected die unit request power determination unit 104 sets the Li layer power limit as the corrected Li layer request power (Step S133).

On the other hand, when the Li layer request power is equal to or less than the Li layer power limit (Step S132: No), the corrected die unit request power determination unit 104 sets the Li layer request power as the corrected Li layer request power (Step S134).

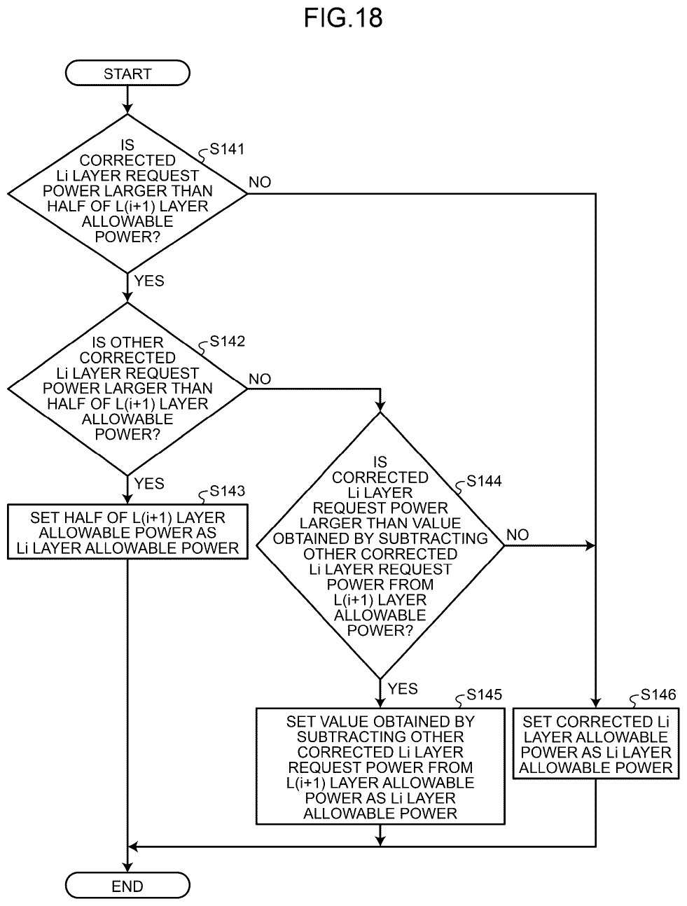

FIG. 18 is a flowchart of determination processing of Li layer allowable power. Each processing performed in the flow of FIG. 18 corresponds to an example of the processing performed in Step S106 in FIG. 15. Here, the processing described below is performed for each of the 2\hat{ }(n−i) Li die groups.

The corrected die unit request power determination unit 104 calculates whether or not the corrected Li layer request power is larger than half of the L(i+1) layer allowable power (Step S141).

When the corrected Li layer request power is larger than half of the L(i+1) layer allowable power (Step S141: Yes), the corrected die unit request power determination unit 104 performs the following processing. That is, the corrected die unit request power determination unit 104 determines whether the other corrected Li layer request power is larger than half of the L(i+1) layer allowable power (Step S142). The other corrected Li layer request power is the corrected Li layer request power for another Li die group connected to the L(i+1) die group to which the Li die group for which the Li layer allowable power is to be determined is connected.

When the other corrected Li layer request power is larger than half of the L(i+1) layer allowable power (Step S142: Yes), the corrected die unit request power determination unit 104 sets half of the L(i+1) layer allowable power as the Li layer allowable power (Step S143).

On the other hand, when the other corrected Li layer request power is half or less than the L(i+1) layer allowable power (Step S142: No), the corrected die unit request power determination unit 104 performs the following processing. That is, the corrected die unit request power determination unit 104 determines whether the corrected Li layer request power is larger than a value obtained by subtracting the other corrected Li layer request power from the L(i+1) layer allowable power (Step S144).

When the corrected Li layer request power is larger than a value obtained by subtracting the other corrected Li layer request power from the L(i+1) layer allowable power (Step S144: Yes), the corrected die unit request power determination unit 104 performs the following processing. That is, the corrected die unit request power determination unit 104 sets a value obtained by subtracting the other corrected Li layer request power from the L(i+1) layer allowable power as the Li layer allowable power (Step S145).

On the other hand, when the corrected Li layer request power is equal to or less than a value obtained by subtracting the other corrected Li layer request power from the L(i+1) layer allowable power (Step S144: No), the corrected die unit request power determination unit 104 performs the following processing. In addition, also in a case where the corrected Li layer request power is half or less of the L(i+1) layer allowable power (Step S141: No), the corrected die unit request power determination unit 104 performs the following processing. That is, the corrected die unit request power determination unit 104 sets the corrected Li layer allowable power as the Li layer allowable power (Step S146).

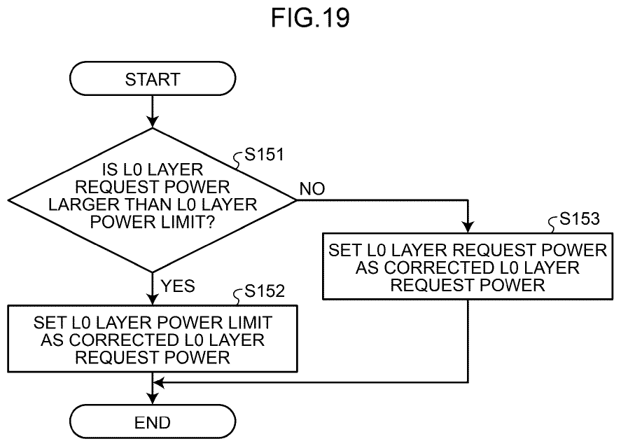

FIG. 19 is a flowchart of determination processing of corrected L0 layer request power. Each processing performed in the flow of FIG. 19 corresponds to an example of the processing performed in Step S109 in FIG. 15. Here, since there are 2\hat{ }n L0 die groups, the processing described below is performed for each of the 2\hat{ }n L0 die groups.

The corrected die unit request power determination unit 104 determines whether the L0 layer request power is larger than the L0 layer power limit (Step S151).

When the L0 layer request power is larger than the L0 layer power limit (Step S151: Yes), the corrected die unit request power determination unit 104 sets the L0 layer power limit as the corrected L0 layer request power (Step S152).

On the other hand, when the L0 layer request power is equal to or less than the L0 layer power limit (Step S151: No), the corrected die unit request power determination unit 104 sets the L0 layer request power as the corrected L0 layer request power (Step S153).

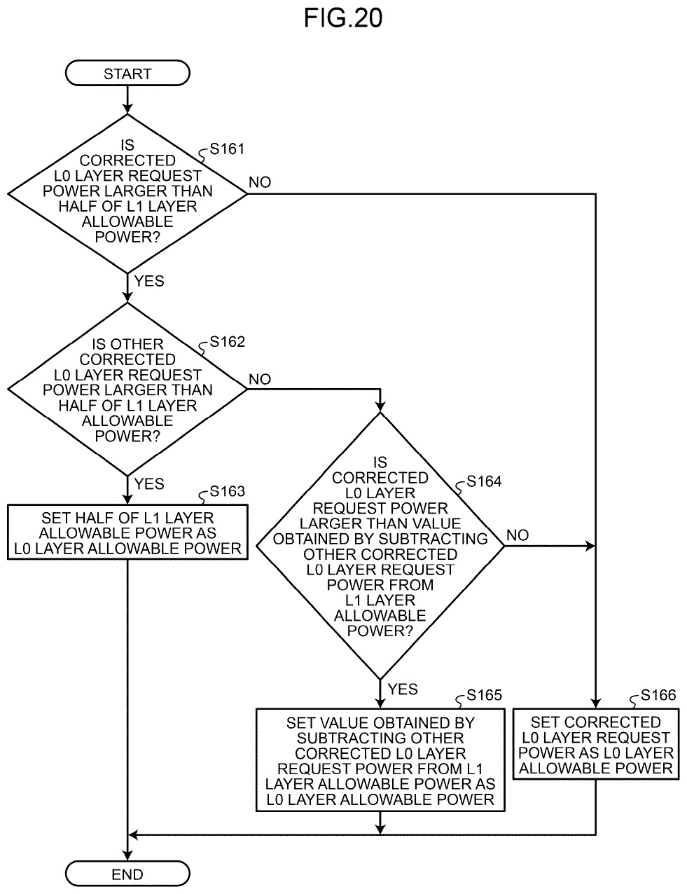

FIG. 20 is a flowchart of determination processing of L0 layer allowable power. Each processing performed in the flow of FIG. 20 corresponds to an example of the processing performed in Step S110 in FIG. 15. Here, the processing described in the following flow is also performed for each of the 2\hat{ }n L0 die groups.

The die unit allowable power determination unit 106 calculates whether or not the corrected L0 layer request power is larger than half of the L1 layer allowable power (Step S161).

When the corrected L0 layer request power is larger than half of the L1 layer allowable power (Step S161: Yes), the die unit allowable power determination unit 106 determines whether the other corrected L0 layer request power is larger than half of the L1 layer allowable power (Step S162). The other corrected L0 layer request power is the corrected L0 layer request power for the other CPU core die 600 connected to the L1 die group 603 to which the CPU core die 600 targeted for determining the L0 layer allowable power is connected.

When the other corrected L0 layer request power is larger than half of the L1 layer allowable power (Step S162: Yes), the die unit allowable power determination unit 106 sets half of the L1 layer allowable power as the L0 layer allowable power (Step S163).

On the other hand, when the other corrected L0 layer request power is half or less than the L1 layer allowable power (Step S162: No), the die unit allowable power determination unit 106 performs the following processing. That is, the die unit allowable power determination unit 106 determines whether the corrected L0 layer request power is larger than a value obtained by subtracting the other corrected L0 layer request power from the L1 layer allowable power (Step S164).

When the corrected L0 layer request power is larger than a value obtained by subtracting the other corrected L0 layer request power from the L1 layer allowable power (Step S164: Yes), the die unit allowable power determination unit 106 performs the following processing. That is, the die unit allowable power determination unit 106 sets a value obtained by subtracting the other corrected L0 layer request power from the L1 layer allowable power as the L0 layer allowable power (Step S165).

On the other hand, when the corrected L0 layer request power is equal to or less than a value obtained by subtracting the other corrected L0 layer request power from the L1 layer allowable power (Step S164: No), the die unit allowable power determination unit 106 performs the following processing. In addition, also when the other corrected L0 layer request power is half or less than the L1 layer allowable power (Step S161: No), the die unit allowable power determination unit 106 performs the following processing. That is, the die unit allowable power determination unit 106 sets the corrected L0 layer request power as the L0 layer allowable power (Step S166).

When the predetermined layer is a Li layer, a layer one level up from the predetermined layer is an L(i+1) layer, and in this case, the die unit allowable power determination unit 106 performs the following processing. That is, the die unit allowable power determination unit 106 determines the allowable power for each Li die group based on the smaller one of the request power and the power limit for each Li die group of the Li layer and the allowable power of the L(i+1) die group of the L(i+1) layer.

Here, in the present embodiment, a case where there is one die group of a plurality of layers connected to one voltage regulator has been described, but in a case where there is a plurality of die groups of a plurality of layers connected to each of a plurality of voltage regulators, a function of a combination of the first embodiment and the second embodiment is provided. In that case, the allowable power adjustment circuit 100 determines the VRM unit allowable voltage for each voltage regulator as in the first embodiment, and then determines the die unit allowable voltage of each CPU core die 600 included in the die group connected to each voltage regulator as in the second embodiment.

As described above, the power adjustment circuit according to the present embodiment includes the die group having the plurality of layer structures, and determines the die unit allowable power for each CPU core die by sequentially determining the allowable power for each die group. As described above, even when the die group has the layer structure, the allowable power can be easily determined, the circuit scale can be reduced, and the increase in the circuit scale and the increase in the circuit complexity when the CPU core die increases can be reduced.

In one aspect, the present invention can reduce an increase in the circuit scale and the circuit complexity.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. A processor comprising:
a plurality of calculation devices;
a first allowable power determination circuit that determines a smaller value of first request power requested by the entire plurality of calculation devices or first power limit for the entire plurality of calculation devices as a first allowable power allowable to the entire plurality of calculation devices;
a second allowable power determination circuit that determines second allowable power for each calculation device based on a smaller value of second request power or second power limit for each calculation device and the first allowable power; and
a transmission circuit that transmits the second allowable power to the calculation device to cause the calculation device to receive supply of the second allowable power.

2. The processor according to claim 1, further comprising:
a third allowable power determination circuit that determines, for each of a plurality of voltage regulators corresponding to each of the groups that supply power to the plurality of calculation devices divided into the plurality of groups, a third allowable power for each of the groups based on a smaller value of third request power requested for the entire calculation devices to which power is to be supplied or third power limit for the entire calculation devices to which power is to be supplied, and the first allowable power,
wherein the second allowable power determination circuit determines second allowable power for each of the calculation devices based on a smaller value of the second request power or the second power limit for each of the calculation devices and the third allowable power.

3. The processor according to claim 2, further comprising:
a corrected third request power determination circuit that calculates the third request power by summing the second request power for each of the calculation devices that supply power for each of the voltage regulators, and sets a smaller value of the third request power or the third power limit as corrected third request power,
wherein the voltage regulator is present in a first predetermined number, and
the third allowable power determination circuit determines the third allowable power for each of the voltage regulators based on the corrected third request power and a value obtained by dividing the first allowable power by the first predetermined number.

4. The processor according to claim 3, further comprising:
a corrected second request power determination circuit that sets a smaller value of the second request power or the second power limit as corrected second request power for each of the calculation devices,
wherein the voltage regulator supplies power to a second predetermined number of the calculation devices, and
the second allowable power determination circuit determines the second allowable power for each of the calculation devices based on the corrected second request power and a value obtained by dividing the third allowable power of the voltage regulator of a power supply source by the second predetermined number.

5. The processor according to claim 1, wherein the first allowable power determination circuit calculates the first request power by summing the second request power of each of the plurality of calculation devices.

6. The processor according to claim 1,
wherein the plurality of calculation devices include a group having a layer structure including a plurality of groups in a layer one level down with each of the calculation devices as a group in a lowest layer, and
the second allowable power determination circuit determines the allowable power for each group of the predetermined layer based on the smaller one of the request power and the power limit for each group of the predetermined layer and the allowable power of the group of the layer one level up from the predetermined layer.

7. An information processing apparatus comprising:
a processor including a plurality of calculation devices and a power adjustment circuit;
one or more voltage regulators corresponding to each of the groups that supply power to a plurality of calculation devices divided into one or more groups; and
a power supply device configured to supply power to the voltage regulator,
wherein the power adjustment circuit includes
a plurality of calculation devices,
a first allowable power determination circuit that determines a smaller value of first request power requested by the entire plurality of calculation devices or first power limit for the entire plurality of calculation devices as a first allowable power allowable to the entire plurality of calculation devices,
a second allowable power determination circuit that determines second allowable power for each calculation device based on a smaller value of second request power or second power limit for each calculation device and the first allowable power, and
a transmission circuit that transmits the second allowable power to the calculation device to cause the calculation device to receive supply of the second allowable power from the voltage regulator.

8. A method for controlling a processor including a plurality of calculation devices, the method comprising:
causing the processor to execute processes of
determining a smaller value of first request power requested by the entire plurality of calculation devices or first power limit for the entire plurality of calculation devices as a first allowable power allowable to the entire plurality of calculation devices;
determining second allowable power for each calculation device based on a smaller value of second request power for each calculation device or second power limit for each calculation device and the first allowable power; and
transmitting the second allowable power to the calculation device to cause the calculation device to receive supply of the second allowable power.
